(19) United States
(12) Patent Application Publication
(10) Pub. No.: US 2025/0203450 A1
(43) Pub. Date: Jun. 19, 2025

(54) DOWNLINK PROVISIONING WITH PREFERRED LINKS

(71) Applicant: QUALCOMM Incorporated, San Diego, CA (US)

(72) Inventors: Gyanranjan HAZARIKA, Milpitas, CA (US); Manish SHUKLA, Milpitas, CA (US); Sandip HOMCHAUDHURI, San Jose, CA (US); Chao ZOU, San Jose, CA (US); Xiaolong HUANG, Santee, CA (US); Rhythm Kamlesh PATWA, Milpitas, CA (US); Yogesh SHEKAR, San Jose, CA (US); Guido Robert FREDERIKS, Watsonville, CA (US); Patrick Poon-Cheuk CHAN, San Jose, CA (US)

(21) Appl. No.: 18/544,131

(22) Filed: Dec. 18, 2023

(51) Int. Cl. H04W 28/02; H04W 76/38

(52) U.S. Cl. CPC H04W 28/0284; H04W 76/38

(57) ABSTRACT

This disclosure provides methods, components, devices and systems for downlink provisioning with preferred links. Some aspects more specifically relate to a multi-link device (MLD) provisioning downlink communication links. In some examples, an access point (AP), which may be an example of an MLD, may identify communication links for a station (STA). The AP may identify preferred communication links based on receiving feedback information about channel conditions of a communication link. The AP may output data transmissions on the preferred communication links, as well as on non-preferred communication links with an offset. The AP may, additionally, or alternatively, output the data transmission on the non-preferred communication links based on failing to gain access to the preferred communication links, or based on receiving feedback information about channel conditions of the preferred communication links.

### TECHNICAL FIELD

This disclosure relates generally to wireless communication and, more specifically, to downlink provisioning with preferred links.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, an AP, such as an AP multi-link device (MLD), may provision a client device, such as a STA, in a set of links available to the client device. In some implementations, the AP may provision a subset of the set of links to the STA based on quality of service (QOS) requirements, service level agreements (SLAs), or both of the client device. For example, the AP may provision a quantity of links to the STA based on a level of congestion at each of the links relative to the QoS requirements, the SLAs, or both. The AP may map traffic identifiers (TIDs) of traffic flows associated with the STA to the provisioned communication links and devise a TID-to-link mapping (T2LM) element. The AP may send a frame including the T2LM element to the STA, and the STA may use the T2LM element to determine which communication links are to be used for communicating traffic flows. The AP may use the congestion level of each communication link as part of provisioning various communication links.

### SUMMARY

The systems, methods, and devices of this disclosure each have several innovative aspects, no single one of which is solely responsible for the desirable attributes disclosed herein.

One innovative aspect of the subject matter described in the disclosure can be implemented in a method for wireless communication performable by an access point (AP). The method may include identifying a first communication link of a first radio block of a set of multiple radio blocks as a preferred link via which to transmit data and a second communication link of a second radio block of the set of multiple radio blocks as a non-preferred link via which to transmit the data, outputting, for transmission by the first radio block, the data and a first indication of a first activation timeout, the first indication having a first duration based on the first communication link being the preferred link, and outputting, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout.

Another innovative aspect of the subject matter described in this disclosure can be implemented in an AP. The AP may include at least one processor; multiple radio blocks associated with multiple communication links, each radio block of the multiple radio blocks associated with a respective communication link of the multiple communication links; and at least one memory including instructions executable by the at least one processor. The instructions may be executable by the at least one processor to cause the AP to identify a first communication link of a first radio block of a set of multiple radio blocks as a preferred link via which to transmit data and a second communication link of a second radio block of the set of multiple radio blocks as a non-preferred link via which to transmit the data, output, for transmission by the first radio block, the data and a first indication of a first activation timeout, the first indication having a first duration based on the first communication link being the preferred link, and output, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout.

Another innovative aspect of the subject matter described in this disclosure can be implemented in an AP. The AP may include means for identifying a first communication link of a first radio block of a set of multiple radio blocks as a preferred link via which to transmit data and a second communication link of a second radio block of the set of multiple radio blocks as a non-preferred link via which to transmit the data, means for outputting, for transmission by the first radio block, the data and a first indication of a first activation timeout, the first indication having a first duration based on the first communication link being the preferred link, and means for outputting, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout.

Another innovative aspect of the subject matter described in this disclosure can be implemented in a non-transitory computer-readable medium storing code for wireless communications by a wireless communication device. The code may include instructions executable by one or more processors to identify a first communication link of a first radio block of a set of multiple radio blocks as a preferred link via which to transmit data and a second communication link of a second radio block of the set of multiple radio blocks as a non-preferred link via which to transmit the data, output, for transmission by the first radio block, the data and a first indication of a first activation timeout, the first indication having a first duration based on the first communication link being the preferred link, and output, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout.

Another innovative aspect of the subject matter described in the disclosure can be implemented in a method for wireless communication performable by an AP. The method may include detecting feedback information about at least one channel condition of the set of multiple communication links, identifying a first communication link of a first radio block of the set of multiple radio blocks via which to transmit data, the identification being based on the at least one channel condition, contending, by the first radio block, for access of the first communication link to transmit the data, identifying a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link, contending, by the second radio block, for access of the second communication link to transmit the data based on identifying the second communication link, and outputting the data for transmission via the second communication link based on contending for access of the second communication link.

Some examples of the method, APs, and non-transitory computer-readable medium described herein may further include operations, features, means, or instructions for contending, by the first radio block, for access of the first communication link to transmit the data, outputting, by the first radio block, the data for transmission via the first communication link based on a successful contention for access to the first communication link, and sending, by the first radio block to the second radio block, a message to cancel the transmission of the data via the second communication link based on the first radio block outputting the data.

Another innovative aspect of the subject matter described in this disclosure can be implemented in an AP. The AP may include at least one processor; multiple radio blocks associated with multiple communication links, each radio block of the multiple radio blocks associated with a respective communication link of the multiple communication links; and at least one memory including instructions executable by the at least one processor. The instructions may be executable by the at least one processor to cause the AP to detect feedback information about at least one channel condition of the set of multiple communication links, identify a first communication link of a first radio block of the set of multiple radio blocks via which to transmit data, the identification being based on the at least one channel condition, contend, by the first radio block, for access of the first communication link to transmit the data, identify a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link, contend, by the second radio block, for access of the second communication link to transmit the data based on identifying the second communication link, and output the data for transmission via the second communication link based on contending for access of the second communication link.

Another innovative aspect of the subject matter described in this disclosure can be implemented in an AP. The AP may include means for detecting feedback information about at least one channel condition of the set of multiple communication links, means for identifying a first communication link of a first radio block of the set of multiple radio blocks via which to transmit data, the identification being based on the at least one channel condition, means for contending, by the first radio block, for access of the first communication link to transmit the data, means for identifying a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link, means for contending, by the second radio block, for access of the second communication link to transmit the data based on identifying the second communication link, and means for outputting the data for transmission via the second communication link based on contending for access of the second communication link.

Another innovative aspect of the subject matter described in this disclosure can be implemented in a non-transitory computer-readable medium storing code for wireless communications by a wireless communication device. The code may include instructions executable by one or more processors to detect feedback information about at least one channel condition of the set of multiple communication links, identify a first communication link of a first radio block of the set of multiple radio blocks via which to transmit data, the identification being based on the at least one channel condition, contend, by the first radio block, for access of the first communication link to transmit the data, identify a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link, contend, by the second radio block, for access of the second communication link to transmit the data based on identifying the second communication link, and output the data for transmission via the second communication link based on contending for access of the second communication link.

Another innovative aspect of the subject matter described in this disclosure can be implemented in an AP. The method may include obtaining first feedback information about at least one channel condition of the set of multiple communication links used to communicate downlink data, provisioning one or more communication links via which to transmit the downlink data using the at least one channel condition, and outputting, for transmission by one or more first radio blocks of the set of multiple radio blocks, the downlink data via the one or more communication links.

Some examples of the method, APs, and non-transitory computer-readable medium described herein may further include operations, features, means, or instructions for identifying whether to use a single preferred link to communicate the data or multiple preferred links to communicate the data, where identifying the first communication link may be based on identifying whether to use the single preferred link or the multiple preferred links.

Another innovative aspect of the subject matter described in this disclosure can be implemented in an AP. The AP may include at least one processor; multiple radio blocks associated with multiple communication links, each radio block of the multiple radio blocks associated with a respective communication link of the multiple communication links; and at least one memory including instructions executable by the at least one processor. The instructions may be executable by the at least one processor to cause the AP to obtain first feedback information about at least one channel condition of the set of multiple communication links used to communicate downlink data, provision one or more communication links via which to transmit the downlink data using the at least one channel condition, and output, for transmission by one or more first radio blocks of the set of multiple radio blocks, the downlink data via the one or more communication links.

Another innovative aspect of the subject matter described in this disclosure can be implemented in an AP. The AP may include means for obtaining first feedback information about at least one channel condition of the set of multiple communication links used to communicate downlink data, means for provisioning one or more communication links via which to transmit the downlink data using the at least one channel condition, and means for outputting, for transmission by one or more first radio blocks of the set of multiple radio blocks, the downlink data via the one or more communication links.

Another innovative aspect of the subject matter described in this disclosure can be implemented in a non-transitory computer-readable medium storing code for wireless communications by a wireless communication device. The code may include instructions executable by one or more processors to obtain first feedback information about at least one channel condition of the set of multiple communication links used to communicate downlink data, provision one or more communication links via which to transmit the downlink data using the at least one channel condition, and output, for transmission by one or more first radio blocks of the set of multiple radio blocks, the downlink data via the one or more communication links.

In some examples of the method, APs, and non-transitory computer-readable medium described herein, the one or more communication links may be for downlink traffic and provisioning the one or more communication links occurs independent of provisioning a communication link for uplink traffic.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example PPDU usable for communications between a wireless AP and one or more wireless STAs.

FIG. 4 shows a pictorial diagram of another example wireless communication network.

FIG. 5 shows an example of a signaling diagram that supports downlink provisioning with preferred links.

FIG. 6 shows an example of a wireless communication system that supports downlink provisioning with preferred links.

FIG. 7 shows an example of a flow diagram that supports downlink provisioning with preferred links.

FIG. 8 shows an example of a wireless communication system that supports downlink provisioning with preferred links.

FIG. 9 shows an example of a flow diagram that supports downlink provisioning with preferred links.

FIG. 10 shows a block diagram of an example wireless communication device that supports downlink provisioning with preferred links.

FIG. 11 through 16 show flowcharts illustrating example processes performable by or at an AP that supports downlink provisioning with preferred links.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communications, including communications via multi-link devices (MLDs). Some aspects more specifically relate to an MLD provisioning downlink communication links. For example, an AP, which may be an example of a MLD, may identify one or more communication links for a STA. Examples of communication links may include a first link for a first radio access technology (such as 4G or 5G) and a second link for a second radio access technology (such as 5G or 6G). Provisioning multiple links may use communication resources and reduce performance for a wireless network. Techniques for prioritizing communication links and more selectively provisioning communication links may improve performance of a wireless network.

In some implementations, the AP may perform downlink-only provisioning in a multi-link environment. For example, the AP may provision downlink communication links to transmit downlink data based on feedback information. That is, the AP may provision the downlink communication links independent of provisioning an uplink communication link, in some implementations.

In some implementations, the AP may identify one or more preferred communication links, one or more non-preferred communication links, or both. For example, the AP may identify the one or more preferred communication links based on receiving feedback information about channel conditions of a communication link. The channel conditions may include a congestion level, traffic characteristics, a collision rate, or any combination thereof (such as channel conditions associated with a quality of service (QOS) or service level agreement (SLA) of the STA).

The AP may contend for the one or more communication links according to various implementations. In a first implementation, the AP may schedule data transmissions on the one or more preferred communication links and the one or more non-preferred communication links (such as a technique with a faster ability to adapt to channel conditions). In a second implementation, the AP may contend for access of one or more first communication links (such as a technique with a slower ability to adapt to channel conditions).

In a first implementation, the AP may schedule data transmissions on the one or more preferred communication links and the one or more non-preferred communication links. The AP may output the data transmission on the one or more preferred communication links with an activation timeout such that the AP may refrain from contending for the one or more preferred communication links based on expiration of the activation timeout. Additionally, or alternatively, the AP may output the data transmission on the one or more non-preferred communication links with an activation timeout and an offset. For example, the AP may begin contending for the one or more preferred communication links after a duration of the offset. In other words, the AP may refrain from contending for the non-preferred communication links until a duration of time has passed such that the contention procedure for the non-preferred communication links may start after the beginning of the contention procedure for the preferred communication links.

In a second implementation, the AP may contend for access of one or more first communication links. For example, the AP may identify one or more second communication links based on failing to gain access to the one or more first communication links. The AP may contend for access of the one or more second communication links based on the identification. That is, the AP may identify and contend for the second links based on failing to gain access to the one or more first links. In some implementations, the AP may identify one or more third communication links (different than the one or more first communication links and/or the one or more second communication links) based on receiving feedback associated with a channel condition for the one or more first communication links or the one or more second communication links. In other words, the AP may select a communication link based on changing channel conditions (such as conditions failing to satisfy the QoS or SLA for the STA).

Particular aspects of the subject matter described in this disclosure can be implemented to realize one or more of the following potential advantages. In some implementations, by performing downlink provisioning with preferred links, the described techniques can be used to reduce latency and overhead associated with provisioning. For example, the AP may identify the preferred links for the STA according to a QoS requirement, an SLA, or both associated with the STA such that the selected communication links satisfy one or more conditions for the STA. The selection of preferred links, as opposed to provisioning all available links, may reduce communication overhead, reduce latency, or both. For example, the AP may reduce a latency associated with provisioning communication links for the STA by selecting a few provisioned links to meet the conditions for the STA, for example, rather than provisioning and contending for all available provisioned links (such as random spraying). Additionally, or alternatively, evaluating the conditions of the communication links in use via feedback received by the AP may reduce latency. For example, evaluating the communication links (such as evaluating the communication links internally by the AP) may reduce latency compared to receiving one or more messages from the STA requesting that new communication links be used or that communication links be re-provisioned. In other words, rather than the AP and STA exchanging one or more messages over-the-air (OTA), the AP may identify one or more channel conditions for at least the downlink provisioned links to determine whether one or more communication links in use satisfy the QoS requirements, the SLA, or both for the STA.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

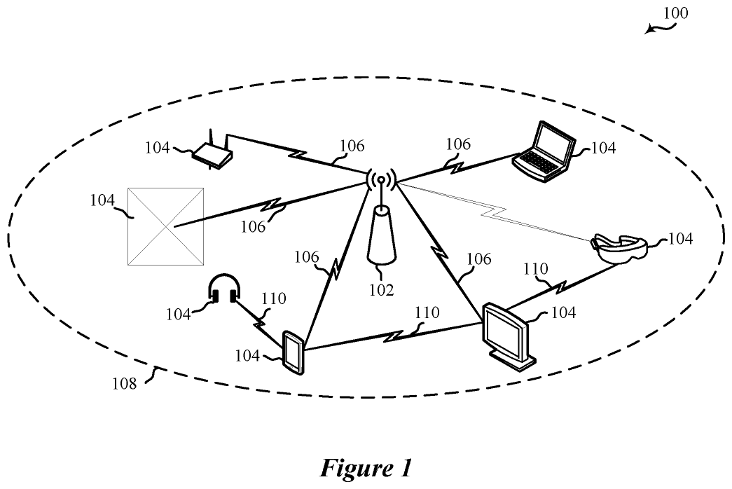

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.1lay, 802.11ax, 802.11az, 802.11ba, 802.11bd, 802.11bc, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU). A wireless node may refer to either an AP or a STA.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz, 160 MHz, 240 MHz, 320 MHz, 480 MHz, or 640 MHz by bonding together multiple 20 MHz channels.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.1 1bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHZ (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHZ bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHZ.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

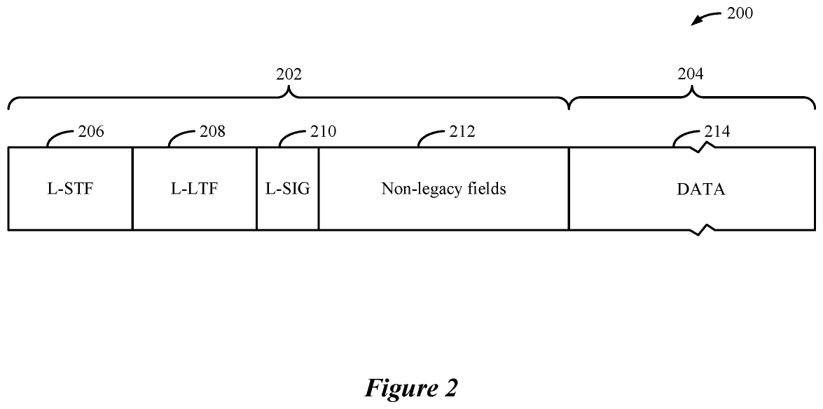

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

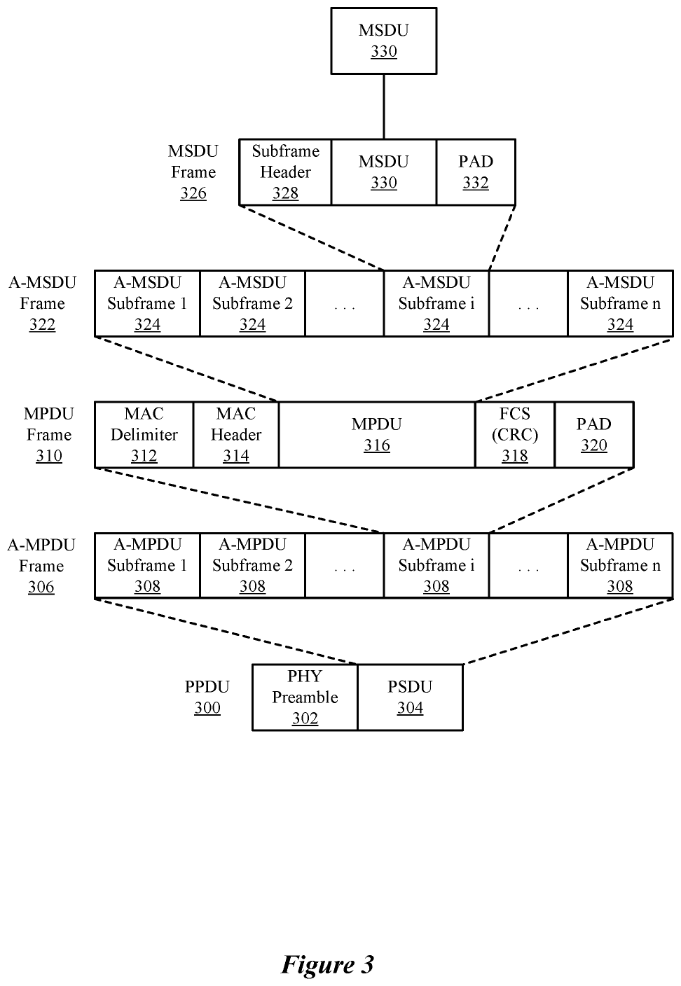

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with (such as an example of or otherwise referred to as) an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some wireless communication devices (including both APs and STAs such as, for example, AP 102 and STAs 104 described with reference to FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. Additionally, or alternatively, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHZ band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally, or alternatively, be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

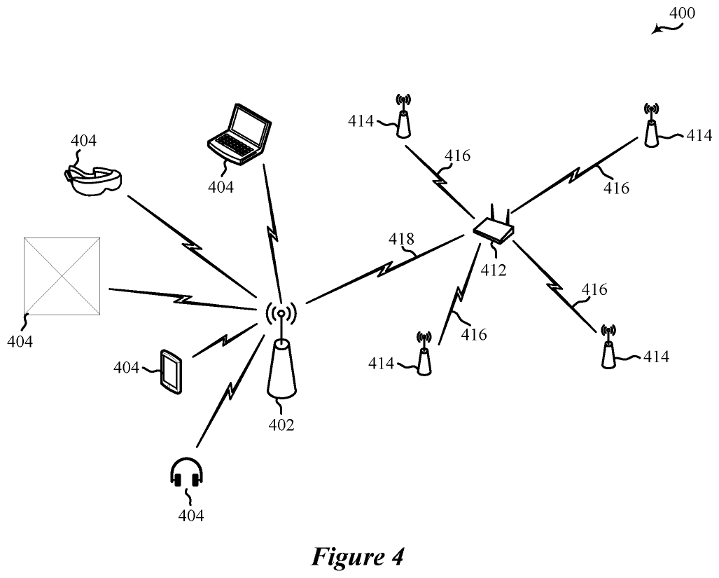

FIG. 4 shows a pictorial diagram of another example wireless communication network 400. According to some aspects, the wireless communication network 400 can be an example of a mesh network, an IoT network, or a sensor network in accordance with one or more of the IEEE 802.11 family of wireless communication protocol standards (including the 802.11ah amendment). The wireless communication network 400 may include multiple wireless communication devices 414, which in some implementations may include APs 402, STAs 404, or both. The wireless communication devices 414 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (such as audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a wireless communication network 100 or a wireless (such as cellular) wide area network (WWAN), which may, in turn, provide access to external networks including the Internet. For example, the intermediate device 412 may associate and communicate, over a Wi-Fi link 418, with an AP 102 of a WLAN network, which also may serve various STAs 104. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

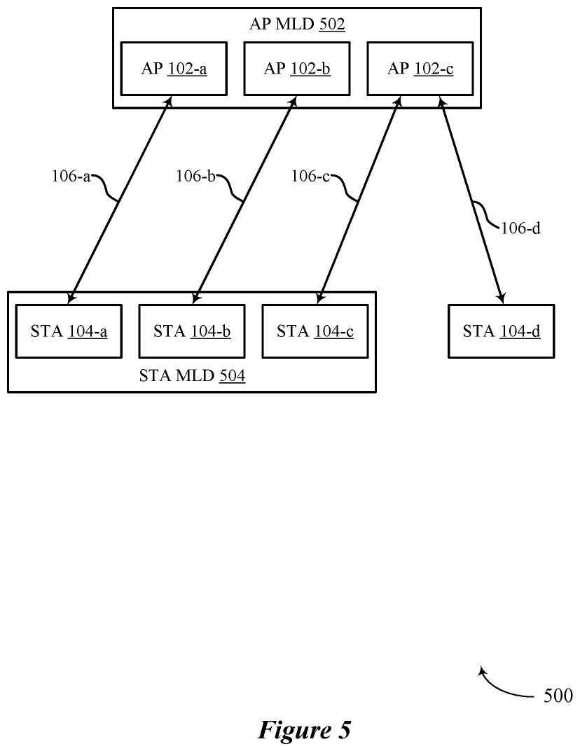

FIG. 5 shows an example of a signaling diagram 500 that supports downlink provisioning with preferred links. The signaling diagram 500 may implement or be implemented to realize one or more aspects of the wireless communication network 100, the PDU 200, the PPDU 300, the wireless communication network 400, or any combination thereof. For example, the signaling diagram 500 illustrates communication between an AP MLD 502 and multiple STAs 104 via communication links 106 which may be examples of the AP 102, the STA 104, and the communication links 106, respectively, as illustrated by and described with reference to FIG. 1.

In some implementations, WLAN devices may include multiple APs or multiple STAs. For example, MLDs may include multiple links associated with respective channels used for data transmission and/or reception. MLDs may enable faster and/or more reliable communications as opposed to single-link WLAN devices.

In the example of the signaling diagram 500, the AP MLD 502 may include an AP 102-a, an AP 102-b, and an AP 102-c. The AP MLD 502 may communicate with one or more STAs, such as a STA MLD 504 including a STA 104-a, a STA 104-b, and a STA 104-c, as well as a STA 104-d, which may be an example of a single-link WLAN device. For example, the AP 102-a may communicate with the STA 104-a via a communication link 106-a, the AP 102-b may communicate with the STA 104-b via a communication link 106-b, and the AP 102-c may communicate with the STA 104-c via a communication link 106-c and with the STA 104-d via the communication link 106-d.

In some aspects, the STA MLD 504, the STA 104-d, or both may be referred to as a client of the AP MLD 502. Additionally, or alternatively the communication links may correspond to frequency bands. In some examples, the communication link 106-a may correspond to a first radio frequency band, the communication link 106-b may correspond to a second radio frequency band, and so on. The first radio frequency band and the second radio frequency band may be the same or different. For example, the first radio frequency band may correspond to a radio frequency band greater than or equal to 5 gigahertz while the second radio frequency band may correspond to a range around 2.4 gigahertz. In some examples, the communication link 106-a may correspond to a first radio access technology (such as Wi-Fi, 3G, 4G, 5G, 6G) and/or a second radio frequency band, the communication link 106-b may correspond to a second radio access technology (such as Wi-Fi, 3G, 4G, 5G, 6G) and/or a second radio frequency band, and so on. The first radio access technology and the second radio access technology may be the same or different.

The AP MLD 502 may configure one or more communication links for the STA MLD 504. For example, the AP MLD 502 may configure the communication link 106-a for the STA 104-a of the STA MLD 504. Configuring the communication link 106-a (as well as additional communication links) may include provisioning and contending for the communication link 106-a.

In some aspects, the AP MLD 502 may configure a set of available communication links (such as all available communication links) for the STA MLD 504. For example, the AP MLD 502 may configure the communication link 106-a, the communication link 106-b, and the communication link 106-c. The AP MLD 502 may configure all available communication links while in a multi-link multi-radio (MLMR) operating mode.

In some aspects, the configuration of all available communication links may be unnecessary to meet one or more thresholds (such as one or more thresholds associated with QoS and/or SLA) at the STA MLD 504, and thus may be associated with excessive overhead and increased latency. For example, the AP MLD 502 may use the communication link 106-a, the communication link 106-b, and the communication link 106-c when a subset of the communication links, such as the communication link 106-a and the communication link 106-b, would meet the one or more thresholds. That is, while the addition of the communication link 106-c also may meet the one or more thresholds, it may be unnecessary given the capabilities established by the communication link 106-a and the communication link 106-b.

Additionally, or alternatively, the contention for all available links may be associated with collisions and/or interference based on one or more other APs or MLDs contending for same resources. That is, the AP 102-a, the AP 102-b, and the AP 102-c may contend for one or more same resources (such as with each other or with other APs), causing collisions and/or interference.

Accordingly, the AP MLD 502 may configure a subset of available communication links according to one or more thresholds (such as a threshold QoS, one or more thresholds associated with an SLA, or the like) associated with the channel conditions for the STA MLD 504. For example, the AP MLD 502 may identify channel conditions at the available communication links and select the subset of available communication links based on comparing the channel conditions to the one or more thresholds for the STA MLD 504.

In some implementations, the AP MLD 502 may determine the subset of available communication links based on receiving multiple traffic identifiers (TIDs) from the STA MLD 504. For example, the TIDs may include information indicative of one or more traffic flows to and/or from the STA MLD 504. The TIDs may include a source and a destination, for example, indicated via an IP address and/or a MAC address. Additionally, or alternatively, the TIDs may indicate an SLA associated with a respective traffic flow. For example, each traffic flow may be associated with a different SLA (such as an SLA requirement) based on the source and/or destination of the traffic flow.

The AP MLD 502 may map the TIDs to one or more communication links between the AP MLD 502 and the STA MLD 504. For example, the AP MLD 502 may map a first traffic flow to the communication link, a second traffic flow to the second communication link 106-b, and so on. In other words, the AP MLD 502 may map the respective traffic flows to respective communication links to satisfy the SLAs associated with each traffic flow. The AP MLD 502 may transmit a TID-to-link mapping (T2LM) element indicating the traffic flows mapped to the communication links.

The transmission of the TIDs and the T2LM element may be associated with one or more OTA messages (such as in a closed-loop OTA interaction). In some implementations, the one or more OTA messages may be associated with latency. For example, the AP MLD 502 and the STA MLD 504 may communicate the TIDs and the T2LM element periodically (such as when one or more channel conditions change at one or more of the communication links). The latency associated with sending these OTA messages may slow a network reconfiguration attempt, delay an alleviation of congestion at one or more communication links, delay an attempt to mitigate an SLA breach, or the like. For example, when one or more communication links of the subset of communication links experience an increased level of congestion or, generally, a change in the condition of the channel, the STA MLD 504 may request that the AP MLD 502 re-map the traffic flows to the communication links, considering new conditions associated with each communication link. The re-mapping and transmission of multiple OTA messages may slow a network response to the increased level of congestion or the change in channel condition(s).

As described herein, the AP MLD 502 may reduce latency and/or overhead associated with communication link provisioning (such as while in the MLMR mode, provisioning via OTA messages, or both) by configuring downlink communication links for the STA MLD 504. For example, the AP MLD 502 may provision one or more downlink communication links for the STA MLD 504 without transmission and/or reception of OTA messages.

In some aspects, the AP MLD 502 may select preferred links for the STA MLD 504 based on an SLA (such as an SLA requirement) of the STA MLD 504 (or respective SLA requirements associated with the STAs of the STA MLD 504). For example, the SLA of the STA MLD 504 may be based on a throughput (such as a best possible throughput), a latency (such as a shortest possible latency), or the like. The AP MLD 502 may select the preferred link based on the SLA.

Additionally, or alternatively, the AP MLD 502 may select the preferred link based on a QoS (such as a QoS requirement). The AP MLD 502 may select a quantity of preferred links in order to meet the QoS, the SLA, or both with a lowest quantity of resources. In other words, the AP MLD 502 may select the quantity of preferred links to meet, but not surpass (and therefore use excessive resources), the QoS, the SLA, or both for the STA MLD 504.

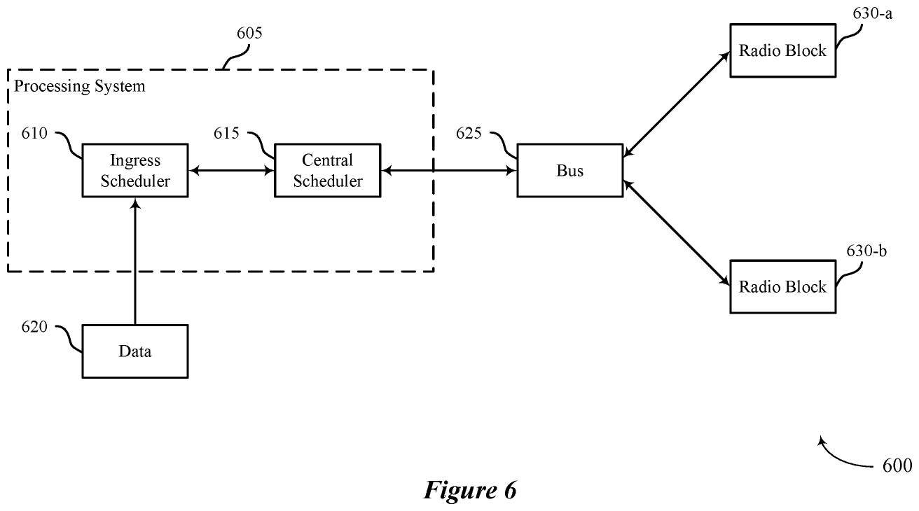

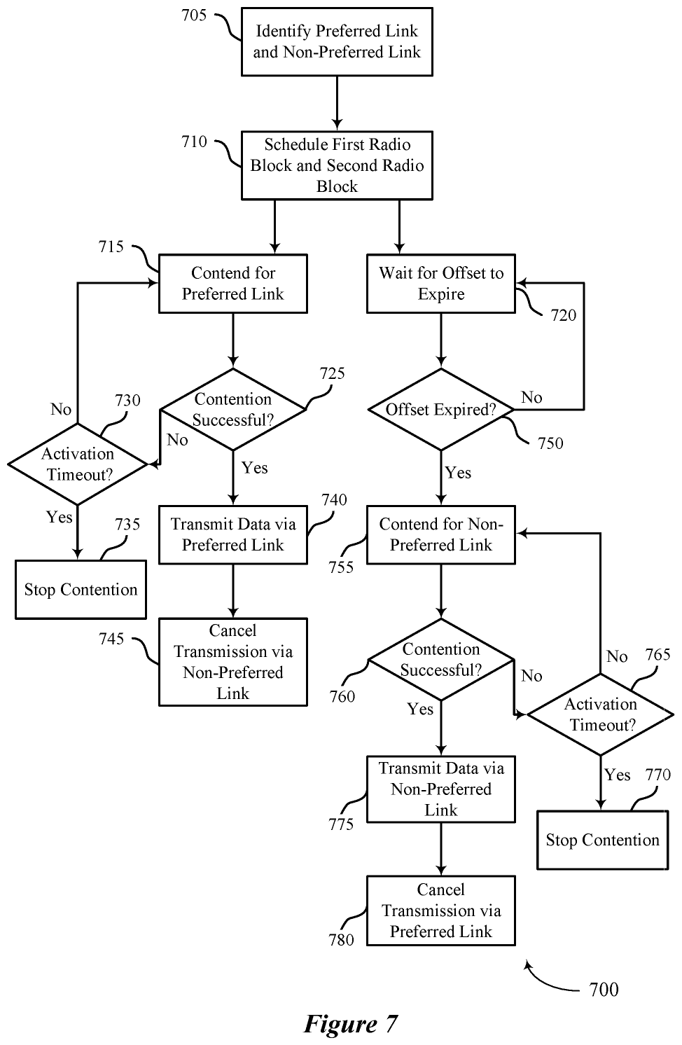

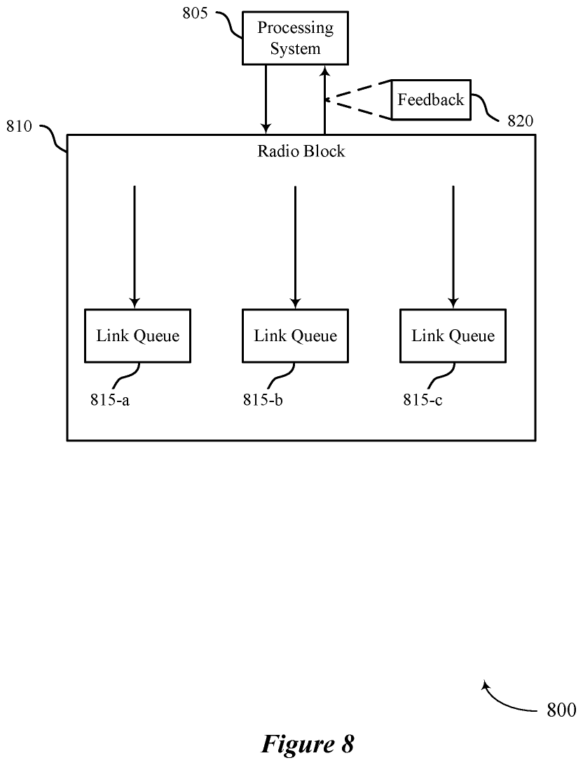

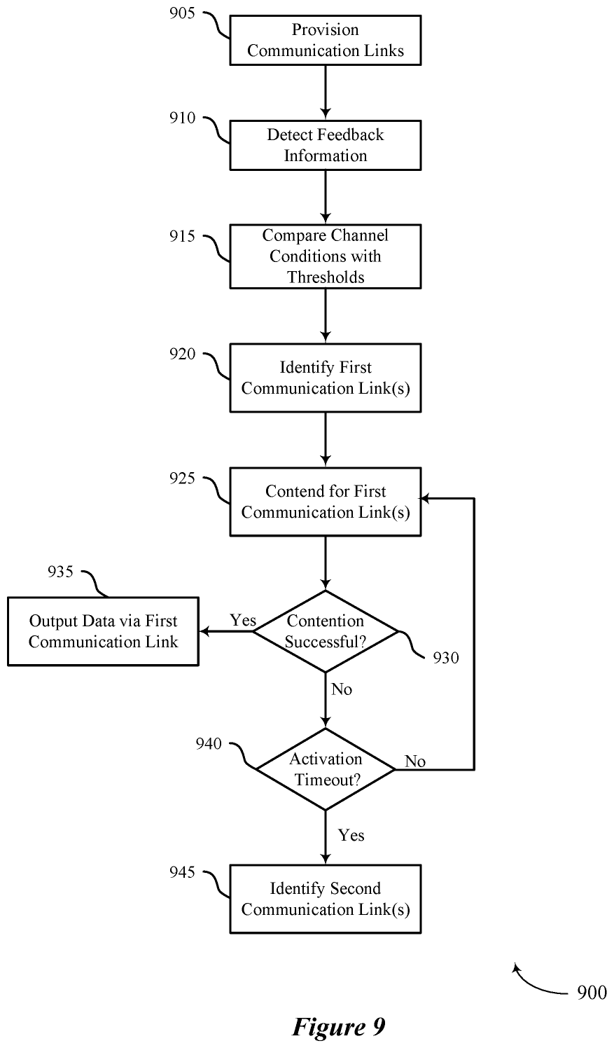

The AP MLD 502 may configure the downlink communication links according to multiple implementations. For example, the AP MLD 502 may configure the downlink communication links according to a first implementation described further with reference to FIGS. 6 and 7, or according to a second implementation described further with reference to FIGS. 8 and 9.

In the first implementation, the AP MLD 502 may output (such as schedule) data transmissions on one or more preferred communication links, one or more non-preferred communication links, or both. For example, the AP MLD 502 may output the data transmissions on the communications link 106-a with a first activation timeout and on the communications link 106-b with a second activation timeout and an offset. That is, the AP MLD 502 may configure an offset for the one or more non-preferred communication links in which the AP MLD 502 may refrain from contending for the link for the duration of the offset.

In the second implementation, the AP MLD 502 may contend for access of the one or more first communication links. For example, the AP MLD 502 may not select one or more second communication links until the AP MLD 502 has failed to gain access to the one or more first links. That is, the AP MLD 502 may contend for the communication link 106-a. In some implementations, the AP MLD 502 may fail to gain access to the communication link 106-a, and may contend for the communication link 106-b (such as a second communication link). In other words, the AP MLD 502 may contend for the communication link 106-b as a backup option.

In some examples, the AP MLD 502 may provision communication links to transmit downlink data according to a channel condition. For example, the AP MLD 502 may obtain feedback about the channel condition and use the feedback to identify one or more communication links to provision. The communication links, in some implementations, may be used for downlink traffic only. That is, the AP MLD 502 may provision the communication links for downlink traffic independent of provisioning communication links for uplink traffic.

In some aspects, the AP MLD 502 may determine whether to use one or multiple communication links. For example, the AP MLD 502 may determine whether to use the one or multiple communication links according to a variety of factors, including a condition of the communication channel. The AP MLD 502 may, in some examples, revise a selection of communication links based on receiving feedback from the STA MLD 504. For example, the AP MLD 502 may select one or more new communication links (such as the same as or different than the initial selection) based on receiving feedback information from the STA MLD 504 related to a condition of the channel. The selection of the one or more new communication links may, again, include determining whether to use one or multiple communication links. In some examples, the STA MLD 504 may select a quantity of communication links to transmit data to the STA MLD 504 up to a threshold quantity of communication links (such as a maximum quantity of communication links). The selection of one or multiple communication links may be used independently of or in addition to the first implementation, the second implementation, or both.

FIG. 6 shows an example of a wireless communication system 600 that supports downlink provisioning with preferred links. The wireless communication system 600 may implement or be implemented to realize one or more aspects of the wireless communication network 100, the PDU 200, the PPDU 300, the wireless communication network 400, the signaling diagram 500, or any combination thereof. For example, the wireless communication system 600 illustrates communication between a processing system 605, a bus 625, and multiple radio blocks 630, which may be examples of elements of the AP 102 or the AP MLD 502 as illustrated by and described with reference to FIG. 1 and FIG. 5, respectively.

The processing system 605 may be an example of processing capabilities of a platform associated with the AP. The processing system 605 may include an ingress scheduler 610 and a central scheduler 615. The ingress scheduler 610 and the central scheduler 615 may be examples of software, firmware, and/or hardware, including one or more processors (alone or in any combination) performing the functions described herein. For example, the processing system 605 and the components of the processing system 605, such as the ingress scheduler 610 and the central scheduler 615, may represent a central processing system of an AP, such as an AP MLD. In some aspects, the ingress scheduler 610 may be referred to as an ingress queue manager. For example, the ingress scheduler 610 may receive data 620 arriving at various ports (such as ingress ports) and schedule the data 620 at various egress ports (such as radio blocks). Additionally, or alternatively, the central scheduler 615 may coordinate between the ingress scheduler 610 and the radio blocks and associated egress schedulers. For example, the central scheduler 615 may activate one or more preferred and/or non-preferred links, resolve priority, and/or resolve head-of-the line blocking.

The bus 625 may be an example of a peripheral component interconnect express (PCIe) or a similar bus. For example, the bus 625 may relay or transfer communications between the processing system 605 and a radio block 630-a, a radio block 630-b, or both. In some aspects, the bus 625 may represent an internal bus or an external bus.

The radio block 630-a, the radio block 630-b, or both may be examples of software, firmware, and/or hardware to cause the wireless communication system 600 to transmit and receive messages over the air for an AP or AP MLD. The radio block 630-a and the radio block 630-b (and/or any other radio blocks that are part of the wireless communication system 600) may be coupled with one or more antennas and/or other components configured to transmit and/or receive messages. In some examples, the radio block 630-a, the radio block 630-b, or both may include an egress scheduler or an egress dispatcher. In some aspects, the radio block 630-a, the radio block 630-b, or both may represent edge-processors. For example, the radio block 630-a and the radio block 630-b may represent one or more processors associated with communication links between the AP MLD and one or more STAs, such as one or more STAs of a STA MLD. In some aspects, the radio block 630-a, the radio block 630-b, or both may be referred to as egress schedulers with back-off engines. For example, the radio block 630-a and the radio block 630-b may send and receive data at various egress ports while running a back-off engine and contending for a transmission opportunity.

The processing system 605, the bus 625, and the radio blocks 630-a and 630-b may be components of an AP MLD in communication with a STA, such as a STA of a STA MLD. For example, the AP MLD including the processing system 605, the bus 625, and the radio blocks 630-a and 630-b may configure one or more communication links for the STA MLD. The AP MLD may select one or more communication links for the STA MLD based on traffic flows (such as traffic flows between the AP MLD and the STA MLD) and conditions of communication links. For example, the AP MLD may select one or more communication links having conditions (such as a collision rate and/or a congestion level) satisfying one or more thresholds associated with the respective traffic flows. That is, the AP MLD may select a first communication link satisfying a first SLA associated with a first traffic flow, a second communication link satisfying a second SLA associated with a second traffic flow, and so on.

The AP MLD may identify the one or more communication links according to a first implementation. For example, the AP MLD may identify the one or more communication links according to a first implementation described with reference to FIG. 6 and FIG. 7, or according to a second implementation described with reference to FIG. 8 and FIG. 9.

In the first implementation, the AP MLD may contend for access to one or more preferred links and one or more non-preferred links. For example, the AP MLD may contend for the one or more preferred links (such as immediately contend). The AP MLD may contend for the one or more non-preferred links after an offset. That is, the AP MLD may contend for the one or more preferred links for at least the duration of the offset before contending for both the one or more preferred links and the one or more non-preferred links. The AP MLD may cancel a transmission scheduled on the one or more preferred links or the one or more non-preferred links based on a transmission via either the one or more preferred links or the one or more non-preferred links. That is, the link which successfully contends for a medium and transmits the downlink traffic may cancel the same transmission scheduled for the other link, which has not transmitted the downlink traffic.

In some aspects, by simultaneously contending for the preferred links and the non-preferred links (such as after the duration of the offset), the first implementation may be associated with less latency than the second implementation, the transmission of multiple OTA messages, or both.

The ingress scheduler 610 may receive the data 620 via multiple ingress ports. The ingress scheduler 610 may, based on receiving the data 620, schedule the data to be transmitted via a radio block according to a link schedule. For example, the ingress scheduler 610 may schedule the data 620 at the radio block 630-a, the radio block 630-b, or both, where the radio block 630-a and the radio block 630-b may be referred to as and/or may be considered in association with respective radio blocks.

The ingress scheduler 610 may select one or more links associated with the radio block 630-a as the one or more preferred links. For example, the ingress scheduler 610 may schedule the data 620 to be transmitted via the radio block 630-a according to a preferred link schedule.

The ingress scheduler 610 may select the one or more links associated with the radio block 630-b as the one or more non-preferred links. Or, the one or more non-preferred links may represent the available links which were not selected as preferred links. In other words, the ingress scheduler 610 may consider the one or more links associated with the radio block 630-b which were not selected as preferred links to be non-preferred links (such as by default).

The ingress scheduler 610 may schedule the data 620 to be transmitted via the radio block 630-b according to a non-preferred link schedule. The non-preferred link schedule may include an offset. For example, the radio block 630-b may refrain from transmitting the data 620 until the duration of the offset has elapsed. In some aspects, the preferred link schedule may be considered to be associated with a zero offset while the non-preferred link schedule may be considered to be associated with a non-zero offset.

The ingress scheduler 610 may schedule the data 620 via the central scheduler 615 and/or via the bus 625. In some aspects, the ingress scheduler 610 may queue respective preferred link and non-preferred link commands in a resident memory of the processing system 605 (such as the processing system 605 including the ingress scheduler 610). The ingress scheduler 610 may communicate the preferred link schedule, the non-preferred link schedule, or both to the central scheduler 615.

The central scheduler 615 may schedule the data 620 to be transmitted via the preferred and non-preferred communication links based on the preferred link schedule and the non-preferred link schedule received from the ingress scheduler 610. For example, the central scheduler 615 may program the radio block 630-a associated with the one or more preferred communication links with the data 620 to be transmitted according to the preferred link schedule. Additionally, or alternatively, the central scheduler 615 may program the radio block 630-b associated with the one or more non-preferred communication links with the data 620 to be transmitted according to the non-preferred link schedule including the offset. In other words, the central scheduler 615 may program preferred and non-preferred link commands, preferred and non-preferred activation timeouts, or both to the respective radio blocks.

The radio block 630-a may retrieve the preferred link command from a programmed location (such as the resident memory of the processing system 605) and contend for the medium according to the activation timeout. Additionally, or alternatively, the radio block 630-b may retrieve the non-preferred link command from the programmed location and contend for the medium according to the activation timeout and based on the offset (such as contending for access after the duration of the offset has elapsed).

The activation timeout may represent a duration that the AP MLD may contend for the medium. For example, the AP MLD may contend for the medium until the activation timeout expires. The processing system 605 may select one or more new preferred links, one or more new non-preferred links, or both based on unsuccessfully contending for the medium in the duration of the activation timeout (for the preferred links, the non-preferred links, or both).

The offset may represent a duration between the start of the activation timeout for the one or more preferred links and the start of the activation timeout for the one or more non-preferred links. For example, the AP MLD may configure the offset such that the AP MLD may have a greater probability of gaining access to the one or more preferred links prior to gaining access to the one or more non-preferred links as opposed to if the contention for the preferred and non-preferred links began simultaneously.

The radio block 630-a or the radio block 630-b may gain access to the respective medium. For example, the radio block 630-a may gain access to the medium prior to the radio block 630-b. Based on gaining access to the medium, the radio block 630-a may transmit a command via the central scheduler 615 to the radio block 630-b to abort the contention for the medium and transmission of the data 620. In other words, the central scheduler 615 may coordinate with the radio block 630-a and the radio block 630-b to cancel queued commands based on transmission of the data 620.

In some aspects, the radio block 630-a may be associated with a busy channel with high contention (such as in a back-off process). For example, the radio block 630-b may, after the duration of the offset, successfully transmit the data 620 prior to the radio block 630-a (such as due to the congestion of the preferred link channel). The radio block 630-b may indicate the transmission to the central scheduler 615, and the central scheduler 615 may cancel the queued command for the radio block 630-a.

In some aspects, the central scheduler 615 may pre-empt and/or prioritize (such as reorder) packets within the radio block 630-a, the radio block 630-b, or both. For example, the central scheduler 615 may reorder one or more commands within the queues of the radio blocks 630-a or 630-b based on QoS characteristics for the one or more preferred links, the one or more non-preferred links, or both. Additionally, or alternatively, the central scheduler 615 may reorder the commands within the queues to avoid head-of-line blocking.

FIG. 7 shows an example of a flow diagram 700 that supports downlink provisioning with preferred links. The flow diagram 700 may implement, or be implemented by, one or more aspects of the wireless communication network 100, the PDU 200, the PPDU 300, the wireless communication network 400, the signaling diagram 500, the wireless communication system 600, or any combination thereof. For example, the flow diagram 700 may be implemented by an AP or AP MLD or the components thereof, which may be an example of corresponding devices described with reference to FIG. 1, FIG. 5, and FIG. 6.

In the following description of the flow diagram 700, the operations may be performed (such as reported or provided) in a different order than the order shown, or the operations performed by the example devices may be performed in different orders or at different times. For example, specific operations also may be left out of the flow diagram 700, or other operations may be added to the flow diagram 700. Further, although some operations or signaling may be shown to occur at different times for discussion purposes, these operations may occur at the same time.

The AP may identify the one or more communication links according to a first implementation. For example, the AP may identify the one or more communication links according to a first implementation described with reference to FIG. 6 and FIG. 7, or according to a second implementation described with reference to FIG. 8 and FIG. 9.

In the first implementation, the AP may contend for access to one or more preferred links and one or more non-preferred links. For example, the AP may contend for the one or more preferred links (such as immediately contend). The AP may contend for the one or more non-preferred links after an offset. That is, the AP may contend for the one or more preferred links for at least the duration of the offset before contending for both the one or more preferred links and the one or more non-preferred links. The AP may cancel a transmission scheduled on the one or more preferred links or the one or more non-preferred links based on a transmission of data via either the one or more preferred links or the one or more non-preferred links. That is, the link which successfully contends for a medium and transmits the data may cancel the same transmission scheduled for the other link, which has not yet contended for the respective link and/or transmitted the downlink traffic.

In some aspects, the AP may include a processor (or multiple processors) and multiple radio blocks associated with respective communication links. For example, the processor may be an example of the processing system 605 as described with reference to FIG. 6. That is, the processor may include an ingress scheduler and a central scheduler. Additionally, or alternatively, the multiple radio blocks may be examples of the radio blocks 630 as described with reference to FIG. 6.

At 705, the AP may identify a preferred link and non-preferred link. For example, the processor may select a first communication link of a first radio block as a preferred link and a second communication link of a second radio block as a non-preferred link. The processor may identify the first communication link and the second communication link via which to transmit data. For example, the AP may identify the preferred link and the non-preferred link via which to transmit data, where the data may be received (such as initially received) by the processor (such as via one or more ingress ports of the processor).

In some aspects, the AP may determine whether to use a single preferred link or multiple preferred links. For example, the AP may select the preferred link at 705 based on determining whether to use a single or multiple preferred links.

Additionally, or alternatively, the first communication link and the second communication link may include a first radio frequency band and a second radio frequency band, respectively. For example, the first radio frequency band may correspond to a radio frequency band greater than or equal to 5 gigahertz while the second radio frequency band may correspond to a range around 2.4 gigahertz.

In some aspects, the AP may identify the first communication link and the second communication link based on provisioning the first communication link and the second communication link for downlink communications. That is, the AP may provision the first communication link and the second communication link for downlink traffic independent of provisioning a communication link for uplink traffic.

At 710, the AP may schedule the first radio block and the second radio block to transmit the data. For example, the AP may schedule the first radio block with a first activation timeout having a first duration based on the first communication link being the preferred link. Additionally, or alternatively, the AP may schedule the second radio block with the second activation timeout having the second duration and an offset based on the second communication link being the non-preferred link. In some aspects, the offset may define a duration between a start of the first duration of the first activation timeout and a start of the second duration of the second activation timeout.

For example, the AP may schedule the first radio block and the second radio block via a central scheduler, which may be an example of the central scheduler 615 as described with reference to FIG. 6.

In some aspects, scheduling the first radio block and the second radio block to transmit the data may include queueing a preferred link command with the first radio block and/or queueing a non-preferred link command with the second radio block.

At 715, the AP may contend for the preferred link. For example, the AP may contend, by the first radio block, for access of the first communication link to transmit the data based on selecting the first communication link (such as selecting the first communication link as the preferred link).

At 720, the AP may wait for the offset to expire. For example, the AP may refrain from contending for access of the second communication link to transmit the data based on the offset not yet expiring. In some aspects, the AP may wait for the offset to expire at the second radio block while simultaneously contending for access of the first communication link at 715 by the first radio block.

At 725, if the contention for the first communication link is unsuccessful, the AP may consider the activation timeout at 730. For example, the AP may consider whether the first duration of the first activation timeout associated with the first communication link has elapsed. The AP may, if the first duration has not elapsed, continue contending for the preferred link at 715. Or, if the first duration has elapsed, the AP may stop the contention procedure at 735.

At 740, if the contention for the first communication link is successful, the AP may transmit the data via the preferred link. For example, the AP may transmit, by the first radio block the data via the first communication link based on contending for access.

At 745, the AP may, by the first radio block to the second radio block, send a message to cancel transmission of the data via the non-preferred communication link. For example, the AP may cancel the transmission of the data via the second communication link based on the data being transmitted by the first communication link.

In some aspects, the first radio block may communicate the cancellation to the processor (such as the processing system and/or the central scheduler). The processor may communicate the cancellation to the second radio block. In other words, the processor may relay and/or coordinate communications between the first radio block and the second radio block. The second radio block may abort the contention (if contention for the second communication link has begun) or otherwise remove the data transmission from a queue associated with the second radio block based on receiving an indication of the cancellation.

At 750, the AP may evaluate whether the duration of the offset has elapsed. For example, the AP may continue waiting for the duration of the offset to expire, or, if the duration of the offset has expired, the AP may contend for the non-preferred link at 755.

For example, the AP may contend, by the second radio block, for access to the second communication link to transmit the data based on the duration of the offset elapsing.

At 760, if the contention for the non-preferred link is unsuccessful, the AP may consider the activation timeout at 765. For example, the AP may consider whether the second duration of the second activation timeout associated with the second communication link has elapsed. The AP may, if the second duration has not elapsed, continue contending for the non-preferred link at 755. Or, if the second duration has elapsed, the AP may stop the contention procedure at 770.

At 775, if the contention procedure is successful, the AP may transmit the data via the non-preferred link. For example, the AP, by the second radio block, may transmit the data via the second communication link based on contending for access.

At 780, the AP may, by the second radio block to the first radio block, send a message to cancel transmission of the data via the preferred communication link. For example, the AP may cancel the transmission of the data via the first communication link based on the data being transmitted by the second communication link.

In some aspects, the second radio block may communicate the cancellation to the processor (such as the processing system and/or the central scheduler). The processor may communicate the cancellation to the first radio block. In other words, the processor may relay and/or coordinate communications between the second radio block and the first radio block. The first radio block may abort the contention or otherwise remove the data transmission from a queue associated with the first radio block based on receiving an indication of the cancellation.

The first radio block and the second radio block may send the cancellation message at 745 and 780, respectively, at any point of the flow diagram 700. For example, the first radio block may send the cancellation message at 745 while the second radio block is waiting for the offset to expire at 720, while the second radio block is contending for the non-preferred link at 755, or at any other point of the flow diagram 700. Additionally, or alternatively, the second radio block may send the cancellation message at 780 while the first radio block is contending for the preferred link at 715, or at any other point of the flow diagram 700.

At any point of the flow diagram 700, the processor may receive feedback information about channel conditions of the first communication link and/or the second communication link. For example, the processor may receive the feedback via the first radio block and/or the second radio block. In some aspects, the processor may re-select one or more communication links as the preferred link based on receiving the feedback. In other words, the AP may revert to 705, regardless of what point in the flow diagram 700 the feedback was received at and reselect the preferred link and the non-preferred link.

The feedback information may include information about a congestion level associated with a communication link, traffic characteristics of the communication link, a collision rate of traffic communicated via the communication link, or any combination thereof. For example, the feedback information may be related to an ability of the communication link to satisfy a QoS threshold, an SLA, or both.

FIG. 8 shows an example of a wireless communication system 800 that supports downlink provisioning with preferred links. The wireless communication system 800 may implement or be implemented to realize one or more aspects of the wireless communication network 100, the PDU 200, the PPDU 300, the wireless communication network 400, the signaling diagram 500, or any combination thereof. For example, the wireless communication system 800 illustrates communication between a processing system 805 and a radio block 810. The wireless communication system may be examples of elements of the AP 102, the AP MLD 502, and/or the wireless communication system 600 as illustrated by and described with reference to FIG. 1, FIG. 5, and FIG. 6, respectively. The processing system 805 and the radio block 810 may be examples of the processing system 605 and the radio blocks 630 illustrated by and described with reference to FIG. 6.

The processing system 805 may be an example of software, firmware, and/or hardware. For example, the processing system 805, may represent a central processing system of an AP, such as an AP MLD.

The radio block 810 may be an example of software, firmware, and/or hardware. For example, the radio block 810 may represent a chip including a radio block, such as a Wi-Fi radio block, associated with a device, such as an AP or an AP MLD. The radio block 810 (and/or any other radio blocks that are part of the wireless communication system 800) may be coupled with one or more antennas and/or other components configured to transmit and/or receive messages. In some aspects, the radio block 810 may represent an edge-processor. That is, the radio block 810 may represent one or more processors associated with communication links between the AP MLD and one or more STAs, such as one or more STAs of a STA MLD.

The processing system 805 and the radio block 810 may be components of an AP MLD in communication with a STA, such as a STA MLD. For example, the AP MLD including the processing system 805 and the radio block 810 may configure one or more communication links for the STA MLD. The AP MLD may select one or more communication links for the STA MLD based on traffic flows (such as traffic flows between the AP MLD and the STA MLD) and conditions of communication links. For example, the AP MLD may select one or more communication links having conditions (such as a collision rate, congestion level, or the like) satisfying one or more thresholds associated with the respective traffic flows. That is, the AP MLD may select a first communication link satisfying a first SLA associated with a first traffic flow, a second communication link satisfying a second SLA associated with a second traffic flow, and so on.

The AP MLD may select the one or more communication links according to a second implementation. For example, the AP MLD may select the one or more communication links according to a first implementation described with reference to FIG. 6 and FIG. 7, or according to a second implementation described with reference to FIG. 8 and FIG. 9.

In the second implementation, the AP MLD may contend for access to the one or more first communication links. The AP MLD may contend for access to one or more second communication links based on a failure to gain access to the one or more first communication links, based on the one or more first communication links failing to meet a threshold (such as a QoS, SLA, or the like). That is, the AP MLD may contend for access to the one or more second communication links as a fallback or backup option based on contention for the one or more first communication links being unsuccessful or based on a condition of the communication link not meeting the threshold.

For example, the processing system 805 may select a first link. The radio block 810 may, based on the selection, queue downlink traffic in a link queue 815-a corresponding to the first link. In some aspects, the processing system 805 may select one or more links as first links. For example, the radio block 810 may schedule the downlink traffic in the link queue 815-a and one or more additional link queues (such as a link queue 815-b).

The processing system 805 may receive feedback 820 from the radio block 810. For example, the radio block 810 may provide the feedback 820 to the processing system 805 indicating one or more conditions of the first link, such as a congestion level, a collision rate, or the like. Additionally, or alternatively, the feedback 820 may include an indication of traffic characteristics associated with a client, such as the STA or STA MLD. For example, the feedback 820 may indicate a change to one or more traffic flows for the client. In some aspects, the radio block 810 may monitor channel conditions and provide the feedback 820 to the processing system 805 periodically. For example, the radio block 810 may indicate a quantity of failures, such as OBSS failures, to the processing system 805 via the feedback.

The radio block 810 may schedule (or re-schedule) downlink traffic based on whether the downlink traffic queued in the first link queue, such as the link queue 815-a, is transmitted. For example, the radio block 810 may re-schedule downlink traffic based on a contention for the first link being unsuccessful, based on one or more conditions associated with the first link failing to meet a threshold (such as a threshold associated with the traffic flows, including a QoS and/or SLA), based on a change in traffic characteristics associated with the client, or any combination thereof. Additionally, or alternatively, the radio block 810 may re-schedule the downlink traffic based on a threshold quantity of OBSS failures occurring. In other words, the radio block 810 may re-schedule the traffic based on unsuccessful transmission of the downlink traffic and/or detecting performance degradation. The downlink traffic may be considered successfully transmitted when the downlink traffic is transmitted before a timeout. That is, the radio block 810 may schedule the downlink traffic with a timeout value, where the expiration of the timeout triggers the re-scheduling.

For example, the radio block 810 may determine that the first link is unsuccessful. Based on determining that the first link is unsuccessful, the radio block 810 may schedule downlink traffic in all available and/or active links (such as in an MLMR mode). That is, the radio block 810 may schedule the downlink traffic in the link queue 815-a, the link queue 815-b, and the link queue 815-c. The radio block 810 may schedule the traffic in all the available and/or active links for a duration before returning to scheduling the downlink traffic in the one or more preferred links. In some aspects, the radio block 810 may provide the feedback 820 to the processing system 805 based on determining that the first link is unsuccessful, based on re-scheduling the traffic, or both.

The processing system 805 may select one or more first links (such as new first links) based on receiving the feedback 820. For example, the processing system 805 may select a first preferred link and a second preferred link associated with the link queue 815-a and the link queue 815-b, respectively. In some aspects, the processing system 805 may increase a quantity of links based on receiving the feedback 820. For example, the processing system 805 may increase the quantity of links based on receiving the feedback 820 indicating that a collision rate and/or a congestion level of the first link increased (relative to when the first preferred link was initially selected). The processing system 805 may select the one or more links being the same as, or different than, the one or more first links selected initially.

The re-selection of the one or more links may be associated with a latency less than a latency associated with exchanging OTA messages. For example, receiving feedback (such as internal feedback) by the processing system 805 from the radio block 810 may be associated with less latency than receiving feedback OTA from the client.

FIG. 9 shows an example of a flow diagram 900 that supports downlink provisioning with preferred links. The flow diagram 900 may implement, or be implemented by, one or more aspects of the wireless communication network 100, the PDU 200, the PPDU 300, the wireless communication network 400, the signaling diagram 500, the wireless communication system 600, the wireless communication system 800, or any combination thereof. For example, the flow diagram 900 may be implemented by an AP or an AP MLD or the components thereof, which may be an example of corresponding devices described with reference to FIG. 1, FIG. 5, and FIG. 6.

In the following description of the flow diagram 900, the operations may be performed (such as reported or provided) in a different order than the order shown, or the operations performed by the example devices may be performed in different orders or at different times. For example, specific operations also may be left out of the flow diagram 900, or other operations may be added to the flow diagram 900. Further, although some operations or signaling may be shown to occur at different times for discussion purposes, these operations may actually occur at the same time.

The AP may identify the one or more communication links according to a second implementation. For example, the AP may identify the one or more communication links according to a first implementation described with reference to FIG. 6 and FIG. 7, or according to a second implementation described with reference to FIG. 8 and FIG. 9.

In the second implementation, the AP may contend for access to the one or more first communication links. The AP may contend for access to one or more second communication links based on a failure to gain access to the one or more first communication links, based on the one or more first communication links failing to meet a threshold (such as a QoS, SLA, or the like). That is, the AP may contend for access to the one or more second communication links as a fallback or backup option based on contention for the one or more first communication links being unsuccessful or based on a condition of the communication link not meeting the threshold.

In some aspects, the AP may include a processing system (including one or more processors working alone or in combination) and multiple radio blocks associated with respective communication links. For example, the processing system may be an example of the processing system 805 as described with reference to FIG. 8. Additionally, or alternatively, the multiple radio blocks may each be examples of the radio block 810 as described with reference to FIG. 8.

At 905, the AP may provision communication links. For example, the AP may provision a first communication link and a second communication link for downlink communications.

At 910, the AP may receive feedback information. For example, the processing system of the AP may receive the feedback information from the multiple radio blocks about channel conditions of the multiple communication links. The feedback information may include a congestion level of a communication link, traffic characteristics of the communication link, a collision rate of traffic communicated via the communication link, or any combination thereof. For example, the feedback information may include one or more parameters related to a QoS, SLA, or both.

At 915, the AP may compare channel conditions with thresholds. For example, the AP may compare the channel conditions received via the feedback information to one or more thresholds. The one or more thresholds may be associated with a QoS and/or SLA corresponding to a traffic flow between the AP and a client, such as a STA.

At 920, the AP may identify one or more first communication links. For example, the AP may select the one or more first communication links of a first radio block of the multiple radio blocks over which to transmit data based on the channel condition received via the feedback information at 910.

In some aspects, the AP may determine whether to use a single link to communicate the data or multiple links to communicate the data. For example, the AP may select the one or more first communication links based on determining whether to use one or multiple links.

Additionally, or alternatively, the AP may identify the one or more first communication links based on whether a collision rate in the one or more first communication links satisfies a threshold associated with a single link. In other words, the AP may select the single link based on the collision rate being below a threshold (such as a pre-programmed threshold).

Throughout the flow diagram 900, the AP may monitor, by the first radio block, channel conditions associated with the one or more first communication links. For example, the first radio block may monitor the channel conditions associated with the one or more first communication links and report (such as continuously report) feedback to the processing system of the AP, at 910 or otherwise.

In some aspects, the AP may select one or more additional communication links of the multiple radio blocks based on receiving feedback information. For example, the AP may select the one or more additional communication links based on feedback information received according to the continuous monitoring of the one or more first communication links by the first radio block.

In some aspects, the AP may receive the feedback information indicating that a first communication link (such as a single initially selected communication link) does not satisfy the threshold. The AP may select one or more communication links in addition to the first communication link based on the threshold not being satisfied by the single communication link.

At 925, the AP may contend for the one or more first communication links. For example, the AP may contend, by the first radio block, for access of the one or more first communication links to transmit the data based on selecting the one or more first communication links.

At 930, if the contention is successful, the AP may transmit the data via the one or more first communication links. Or, if the contention is unsuccessful, the AP may consider whether a duration of an activation timeout has elapsed at 940. For example, the one or more first communication links may be associated with an activation timeout having a duration. The duration may be based on the one or more first communication links being preferred links.

At 940, if the duration of the activation timeout has not yet elapsed, the AP may continue contending for the one or more first communication links. Or, if the duration of the activation timeout has elapsed, the AP may select one or more second communication links at 945.

At any point of the flow diagram 900, the AP may cancel a transmission of the data via the one or more first communication links based on receiving additional feedback about the one or more first communication links. For example, the feedback information may indicate that the one or more first communication links do not satisfy the channel condition. In some aspects, the AP may cancel the transmission of the data via the one or more first communication links based on the continuous monitoring.

The AP may identify, by the processing system, one or more second communication links of one or more second radio blocks of the multiple radio blocks over which to transmit the data at 945. The AP identify select the one or more second communication links based on a failure to gain access of the first communication link before the activation timeout occurs, based on receiving the additional feedback, based on cancelling the transmission of data via the one or more first communication links, or any combination thereof.

In some aspects, the AP may select the one or more second communication links from a set of available communication links. For example, the AP may select a second communication link and one or more additional available communication links of the multiple radio blocks based on receiving feedback information (such as additional feedback information) about the one or more first communication links. In other words, the AP may select the one or more second communication links based on receiving feedback information about the one or more first communication links. In some aspects, the additional feedback may be received based on the continuous monitoring.

Throughout the flow diagram 900, the AP may monitor, by the second radio block, channel conditions associated with the one or more second communication links. For example, the second radio block may monitor the channel conditions associated with the one or more second communication links and report (such as continuously report) feedback to the processing system of the AP.

In some aspects, the AP may, by the second radio block, contend for access of the one or more second communication links to transmit the data. The AP may, based on gaining access to the one or more second communication links, transmit the data. The one or more second communication links may be associated with a second activation timeout. In some aspects, the second activation timeout may be based on the one or more second communication links being non-preferred links.

The first communication link and the second communication link may include a first radio frequency band and a second radio frequency band, respectively. For example, the first radio frequency band may correspond to a radio frequency band greater than or equal to 5 gigahertz while the second radio frequency band may correspond to a range around 2.4 gigahertz. Additionally, or alternatively, the one or more first communication links may represent one or more preferred links while the one or more second communication links may represent one or more non-preferred links.

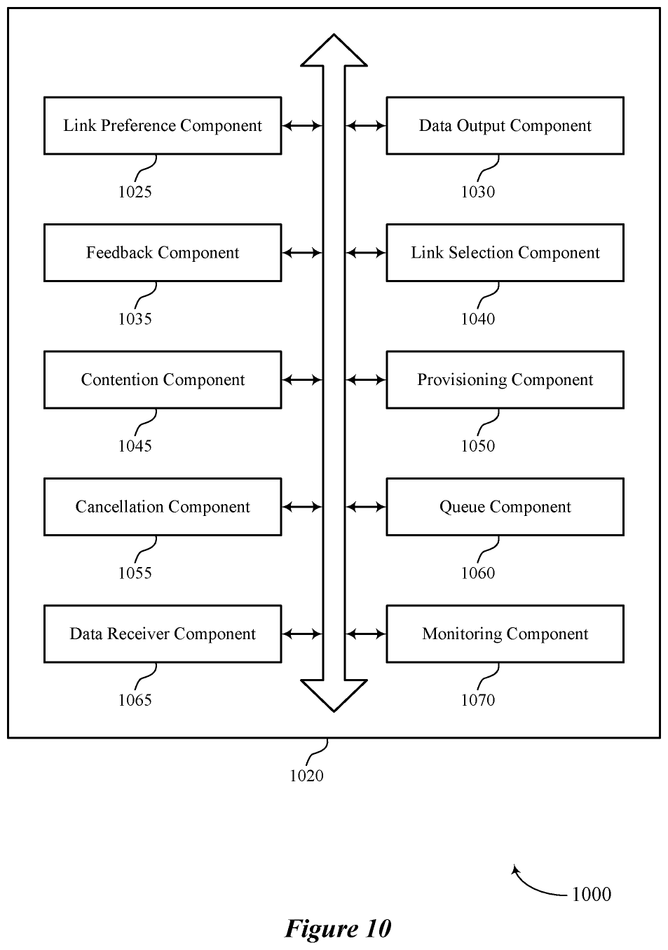

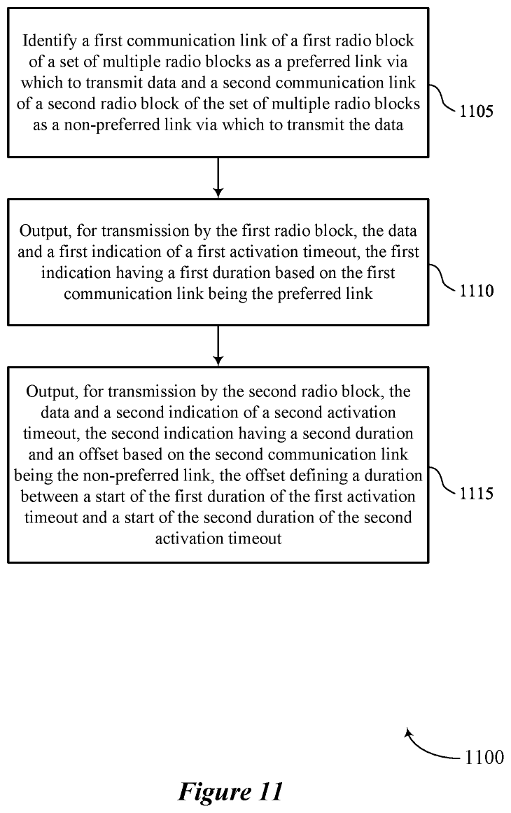

FIG. 10 shows a block diagram of an example wireless communication device 1000 that supports downlink provisioning with preferred links. In some examples, the wireless communication device 1000 is configured to perform the processes 1100, 1200, 1300, 1400, 1500, and 1600 described with reference to FIGS. 11, 12, 13, 14, 15, and 16, respectively. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

Further, various components of the wireless communication device 1000 may provide means for performing the methods described herein. In some examples, means for transmitting and/or receiving may include the transceivers and/or antenna(s) of the wireless communication device 1000. In some examples, means for outputting or sending (such as means for outputting for transmission) and means for obtaining (such as means for obtaining after information is received from a different device) may include one or more interfaces of the wireless communication device 1000 to output signals to other components or obtain signals from other components of the wireless communication device 1000. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for identifying, means for contending, means for queueing, means for detecting, means for canceling, means for comparing, and/or means for provisioning, include a processing system, processor circuitry (including one or more processors), memory circuitry, and/or computer-readable media of the wireless communication device 1000.

The processing system of the wireless communication device 1000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a link preference component 1025, a data output component 1030, a feedback component 1035, a link selection component 1040, a contention component 1045, a provisioning component 1050, a cancellation component 1055, a queue component 1060, a data receiver component 1065, and a monitoring component 1070. Portions of one or more of the link preference component 1025, the data output component 1030, the feedback component 1035, the link selection component 1040, the contention component 1045, the provisioning component 1050, the cancellation component 1055, the queue component 1060, the data receiver component 1065, and the monitoring component 1070 may be implemented at least in part in hardware or firmware. For example, one or more of the link preference component 1025, the data output component 1030, the feedback component 1035, the link selection component 1040, the contention component 1045, the provisioning component 1050, the cancellation component 1055, the queue component 1060, the data receiver component 1065, and the monitoring component 1070 may be implemented at least in part by at least a processor or a modem. In some examples, portions of one or more of the link preference component 1025, the data output component 1030, the feedback component 1035, the link selection component 1040, the contention component 1045, the provisioning component 1050, the cancellation component 1055, the queue component 1060, the data receiver component 1065, and the monitoring component 1070 may be implemented at least in part by a processor and software in the form of processor-executable code stored in memory.

The wireless communication device 1000 may support wireless communications in accordance with examples as disclosed herein. The link preference component 1025 is configurable or configured to identify a first communication link of a first radio block of a set of multiple radio blocks as a preferred link via which to transmit data and a second communication link of a second radio block of the set of multiple radio blocks as a non-preferred link via which to transmit the data. The data output component 1030 is configurable or configured to output, for transmission by the first radio block, the data and a first indication of a first activation timeout, the first indication having a first duration based on the first communication link being the preferred link. In some examples, the data output component 1030 is configurable or configured to output, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout.

In some examples, the contention component 1045 is configurable or configured to contend, by the first radio block, for access of the first communication link to transmit the data. In some examples, the data output component 1030 is configurable or configured to output, by the first radio block, the data for transmission via the first communication link based on a successful contention for access to the first communication link. In some examples, the cancellation component 1055 is configurable or configured to send, by the first radio block to the second radio block, a message to cancel the transmission of the data via the second communication link based on the first radio block outputting the data.

In some examples, the contention component 1045 is configurable or configured to contend, by the first radio block, for access of the first communication link to transmit the data. In some examples, the contention component 1045 is configurable or configured to contend, by the second radio block, for access to the second communication link to transmit the data after the duration of the offset has elapsed. In some examples, the data output component 1030 is configurable or configured to output, by the second radio block, the data for transmission via the second communication link based at least in part an unsuccessful contention for access to the first communication link. In some examples, the cancellation component 1055 is configurable or configured to send, by the second radio block to the first radio block, a message to cancel the transmission of the data via the first communication link based on the second radio block outputting the data.

In some examples, the queue component 1060 is configurable or configured to queue a preferred link command with the first radio block. In some examples, the queue component 1060 is configurable or configured to queue a non-preferred link command with the second radio block, where the outputting of the data to the first radio block is after queuing the preferred link command and the outputting of the data to the second radio block is based on the non-preferred link command.

In some examples, the feedback component 1035 is configurable or configured to obtain feedback information about at least one channel condition of the first communication link or the second communication link. In some examples, the data output component 1030 is configurable or configured to output, for transmission by the first radio block or the second radio block, the data and a third indication of a third activation timeout having a third duration based on the feedback information.

In some examples, the feedback information includes at least one of a congestion level associated with a communication link, one or more traffic characteristics of the communication link, a collision rate of traffic communicated via the communication link, or any combination thereof.

In some examples, identifying the first communication link is based on whether a single preferred link to communicate the data is being used or multiple preferred links to communicate the data are being used.

In some examples, the data receiver component 1065 is configurable or configured to obtain the data for transmission to a wireless node, where identifying the first communication link as the preferred link and the second communication link as the non-preferred link is based on the data.

In some examples, the first communication link includes a first radio frequency band and the second communication link includes a second radio frequency band.

In some examples, the first radio frequency band is greater than or equal to 5 gigahertz and the second radio frequency band is approximately 2.4 gigahertz.

In some examples, the data receiver component 1065 is configurable or configured to obtain data from various ports and output the data for transmission over various communication links. In some examples, the data output component 1030 is configurable or configured to obtain schedules, outputting the data to the set of multiple radio blocks, and identifying activation timeouts.

Additionally, or alternatively, the wireless communication device 1000 may support wireless communications in accordance with examples as disclosed herein. The feedback component 1035 is configurable or configured to detect feedback information about at least one channel condition of the set of multiple communication links. The link selection component 1040 is configurable or configured to identify a first communication link of a first radio block of the set of multiple radio blocks via which to transmit data, the identification being based on the at least one channel condition. The contention component 1045 is configurable or configured to contend, by the first radio block, for access of the first communication link to transmit the data. In some examples, the link selection component 1040 is configurable or configured to identify a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link. In some examples, the contention component 1045 is configurable or configured to contend, by the second radio block, for access of the second communication link to transmit the data based on identifying the second communication link. In some examples, the data output component 1030 is configurable or configured to output the data for transmission via the second communication link based on contending for access of the second communication link.

In some examples, the link selection component 1040 is configurable or configured to identify whether to use a single preferred link to communicate the data or multiple preferred links to communicate the data, where identifying the first communication link is based on identifying whether to use the single preferred link or the multiple preferred links.

In some examples, identifying the first communication link is further based on whether a collision rate in the first communication link satisfies a threshold associated with operating as a single preferred link.

In some examples, the cancellation component 1055 is configurable or configured to cancel a transmission of the data via the first communication link based on additional feedback information about the first communication link, where identifying the second communication link is based on the cancellation.

In some examples, the link selection component 1040 is configurable or configured to identify, in addition to the second communication link, additional available communication links of the set of multiple radio blocks over which to transmit the data, said identification being based on additional feedback information about the first communication link.

In some examples, the link selection component 1040 is configurable or configured to identify, in addition to the first communication link, additional communication links of the set of multiple radio blocks over which to transmit the data as preferred links, said identification being based on the feedback information, where contending for the access further includes contending for access on the additional communication links.

In some examples, the feedback component 1035 is configurable or configured to obtain, at the at least one processor, additional feedback information about the at least one channel condition of the first communication link, where identifying the second communication link is based on obtaining the additional feedback information.

In some examples, the feedback information includes at least one of a congestion level about a communication link, traffic characteristics of the communication link, a collision rate of traffic communicated via the communication link, or any combination thereof.

In some examples, the first communication link includes a first radio frequency band and the second communication link includes a second radio frequency band.

In some examples, the first radio frequency band is greater than or equal to 5 gigahertz and the second radio frequency band is around 2.4 gigahertz.

In some examples, the provisioning component 1050 is configurable or configured to provision the first communication link and the second communication link for downlink communications, where the feedback information is based on provisioning the first communication link and the second communication link.

In some examples, the link selection component 1040 is configurable or configured to compare the at least one channel condition with one or more thresholds, where identifying the first communication link is based on the comparison.

In some examples, the monitoring component 1070 is configurable or configured to monitor, by the first radio block, channel conditions associated with the first communication link. In some examples, the monitoring component 1070 is configurable or configured to monitor, by the second radio block, channel conditions associated with the second communication link, where identifying the first communication link is based on at least one of monitoring by the first radio block or monitoring by the second radio block.

In some examples, the first communication link is a preferred link for transmitting the data and the second communication link is a non-preferred link for transmitting the data.

Additionally, or alternatively, the wireless communication device 1000 may support wireless communications in accordance with examples as disclosed herein. In some examples, the feedback component 1035 is configurable or configured to obtain first feedback information about at least one channel condition of the set of multiple communication links used to communicate downlink data. The provisioning component 1050 is configurable or configured to provision one or more communication links via which to transmit the downlink data using the at least one channel condition. In some examples, the data output component 1030 is configurable or configured to output, for transmission by one or more first radio blocks of the set of multiple radio blocks, the downlink data via the one or more communication links.

In some examples, the one or more communication links are for downlink traffic and provisioning the one or more communication links occurs independent of provisioning a communication link for uplink traffic. Additionally, or alternatively, the provisioning component 1050 may provision the one or more communication links without exchanging information between the wireless communication device 1000 and a STA.

In some examples, the link selection component 1040 is configurable or configured to identify whether to use a single link to communicate the downlink data or multiple links to communicate the downlink data, where identifying the one or more communication links is based on identifying whether to use the single link or the multiple links.

In some examples, the feedback component 1035 is configurable or configured to obtain second feedback information about at least one second channel condition of the set of multiple communication links. In some examples, the provisioning component 1050 is configurable or configured to provision one or more second communication links of one or more second radio blocks of the set of multiple radio blocks via which to transmit data using the at least one second channel condition. In some examples, the data output component 1030 is configurable or configured to output, for transmission by the one or more second radio blocks, the downlink data via the one or more second communication links.

In some examples, provisioning of the one or more communication links is based on satisfying a threshold quantity of communication links, a quantity of the one or more communication links being below the threshold quantity of communication links.

In some examples, to support outputting the downlink data for transmission by the one or more first radio blocks, the data output component 1030 is configurable or configured to output, for transmission by a first radio block of the set of multiple radio blocks, the downlink data and a first indication of a first activation timeout having a first duration based on a first communication link of the one or more communication links of the first radio block being a preferred link. In some examples, to support outputting the downlink data for transmission by the one or more first radio blocks, the data output component 1030 is configurable or configured to output, for transmission by a second radio block of the plurality of radio blocks, the downlink data and a second indication of a second activation timeout having a second duration and an offset based on a second communication link of the one or more communication links being a non-preferred link, the offset defining a duration between a start of the first duration of the first activation timeout and a start of the second duration of the second activation timeout.

In some examples, the contention component 1045 is configurable or configured to contend for access of the one or more communication links to transmit the downlink data. In some examples, the link selection component 1040 is configurable or configured to identify one or more second communication links of one or more second radio blocks of the set of multiple radio blocks via which to transmit the downlink data in response to the contention resulting in a failure to gain access of the one or more communication links before an activation timeout occurs, where a duration of the activation timeout is based on the one or more communication links being preferred over the one or more second communication links. In some examples, the contention component 1045 is configurable or configured to contend, by the one or more second radio blocks, for access of the one or more second communication links to transmit the downlink data based on identifying the one or more second communication links. In some examples, the data output component 1030 is configurable or configured to output the downlink data for transmission via the one or more second communication links based on contending for access of the one or more second communication links.

FIG. 11 shows a flowchart illustrating an example process 1100 performable by or at an AP that supports downlink provisioning with preferred links. The operations of the process 1100 may be implemented by an AP or its components as described herein. For example, the process 1100 may be performed by a wireless communication device, such as the wireless communication device 1000 described with reference to FIG. 10, operating as or within a wireless AP. In some examples, the process 1100 may be performed by a wireless AP, such as one of the APs 102 described with reference to FIG. 1.

In some examples, in block 1105, the AP may identify a first communication link of a first radio block of a set of multiple radio blocks as a preferred link via which to transmit data and a second communication link of a second radio block of the set of multiple radio blocks as a non-preferred link via which to transmit the data. The operations of block 1105 may be performed in accordance with examples as disclosed herein. In some implementations, aspects of the operations of block 1105 may be performed by a link preference component 1025 as described with reference to FIG. 10.

In some examples, in block 1110, the AP may output, for transmission by the first radio block, the data and a first indication of a first activation timeout, the first indication having a first duration based on the first communication link being the preferred link. The operations of block 1110 may be performed in accordance with examples as disclosed herein. In some implementations, aspects of the operations of block 1110 may be performed by a data output component 1030 as described with reference to FIG. 10.

In some examples, in block 1115, the AP may output, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout. The operations of block 1115 may be performed in accordance with examples as disclosed herein. In some implementations, aspects of the operations of block 1115 may be performed by a data output component 1030 as described with reference to FIG. 10.

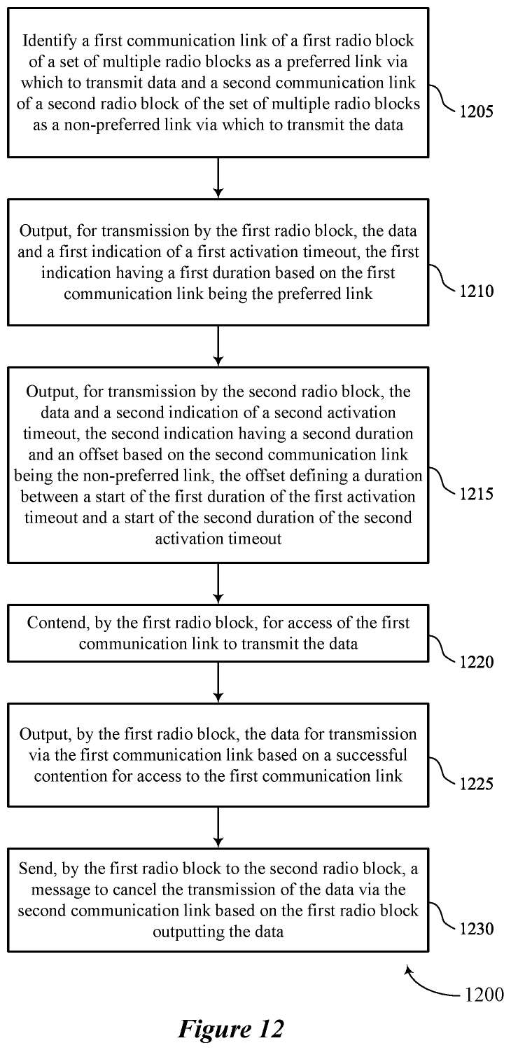

FIG. 12 shows a flowchart illustrating an example process 1200 performable by or at an AP that supports downlink provisioning with preferred links. The operations of the process 1200 may be implemented by an AP or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in block 1205, the AP may identify a first communication link of a first radio block of a set of multiple radio blocks as a preferred link via which to transmit data and a second communication link of a second radio block of the set of multiple radio blocks as a non-preferred link via which to transmit the data. The operations of block 1205 may be performed in accordance with examples as disclosed herein. In some implementations, aspects of the operations of block 1205 may be performed by a link preference component 1025 as described with reference to FIG. 10.

In some examples, in block 1210, the AP may output, for transmission by the first radio block, the data and a first indication of a first activation timeout, the first indication having a first duration based on the first communication link being the preferred link. The operations of block 1210 may be performed in accordance with examples as disclosed herein. In some implementations, aspects of the operations of block 1210 may be performed by a data output component 1030 as described with reference to FIG. 10.

In some examples, in block 1215, the AP may output, for transmission by the second radio block, the data and a second indication of a second activation timeout, the second indication having a second duration and an offset based on the second communication link being the non-preferred link, the offset defining a duration between a start of the first duration of the first activation timeout and a start of the second duration of the second activation timeout. The operations of block 1215 may be performed in accordance with examples as disclosed herein. In some implementations, aspects of the operations of block 1215 may be performed by a data output component 1030 as described with reference to FIG. 10.

In some examples, in block 1220, the AP may contend, by the first radio block, for access of the first communication link to transmit the data. The operations of block 1220 may be performed in accordance with examples as disclosed herein. In some implementations, aspects of the operations of block 1220 may be performed by a contention component 1045 as described with reference to FIG. 10.

In some examples, in block 1225, the AP may output, by the first radio block, the data for transmission via the first communication link based on a successful contention for access to the first communication link. The operations of block 1225 may be performed in accordance with examples as disclosed herein. In some implementations, aspects of the operations of block 1225 may be performed by a data output component 1030 as described with reference to FIG. 10.

In some examples, in block 1230, the AP may send, by the first radio block to the second radio block, a message to cancel the transmission of the data via the second communication link based on the first radio block outputting the data. The operations of block 1230 may be performed in accordance with examples as disclosed herein. In some implementations, aspects of the operations of block 1230 may be performed by a cancellation component 1055 as described with reference to FIG. 10.

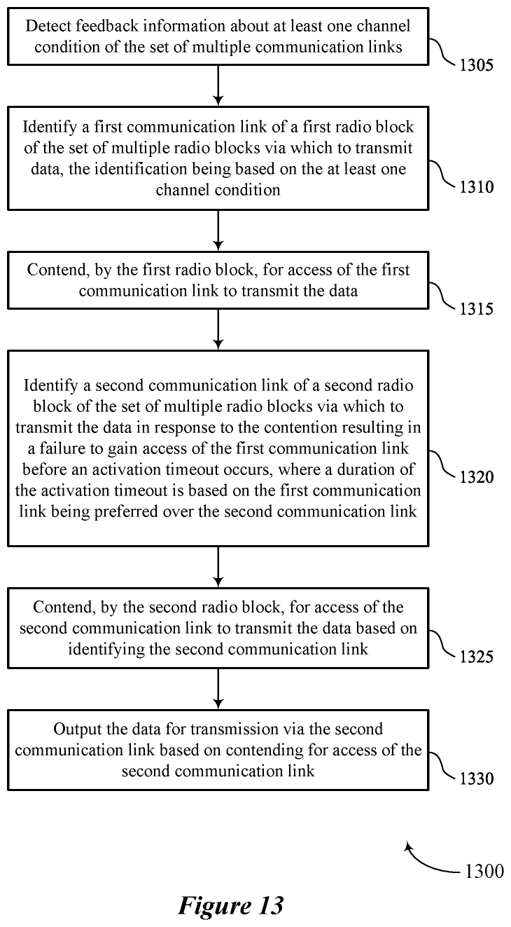

FIG. 13 shows a flowchart illustrating an example process 1300 performable by or at an AP that supports downlink provisioning with preferred links. The operations of the process 1300 may be implemented by an AP or its components as described herein. For example, the process 1300 may be performed by a wireless communication device, such as the wireless communication device 1000 described with reference to FIG. 10, operating as or within a wireless AP. In some examples, the process 1300 may be performed by a wireless AP, such as one of the APs 102 described with reference to FIG. 1.

In some examples, in block 1305, the AP may detect feedback information about at least one channel condition of the set of multiple communication links. The operations of block 1305 may be performed in accordance with examples as disclosed herein. In some implementations, aspects of the operations of block 1305 may be performed by a feedback component 1035 as described with reference to FIG. 10.

In some examples, in block 1310, the AP may identify a first communication link of a first radio block of the set of multiple radio blocks via which to transmit data, the identification being based on the at least one channel condition. The operations of block 1310 may be performed in accordance with examples as disclosed herein. In some implementations, aspects of the operations of block 1310 may be performed by a link selection component 1040 as described with reference to FIG. 10.

In some examples, in block 1315, the AP may contend, by the first radio block, for access of the first communication link to transmit the data. The operations of block 1315 may be performed in accordance with examples as disclosed herein. In some implementations, aspects of the operations of block 1315 may be performed by a contention component 1045 as described with reference to FIG. 10.

In some examples, in block 1320, the AP may identify a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link. The operations of block 1320 may be performed in accordance with examples as disclosed herein. In some implementations, aspects of the operations of block 1320 may be performed by a link selection component 1040 as described with reference to FIG. 10.

In some examples, in block 1325, the AP may contend, by the second radio block, for access of the second communication link to transmit the data based on identifying the second communication link. The operations of block 1325 may be performed in accordance with examples as disclosed herein. In some implementations, aspects of the operations of block 1325 may be performed by a contention component 1045 as described with reference to FIG. 10.

In some examples, in block 1330, the AP may output the data for transmission via the second communication link based on contending for access of the second communication link. The operations of block 1330 may be performed in accordance with examples as disclosed herein. In some implementations, aspects of the operations of block 1330 may be performed by a data output component 1030 as described with reference to FIG. 10.

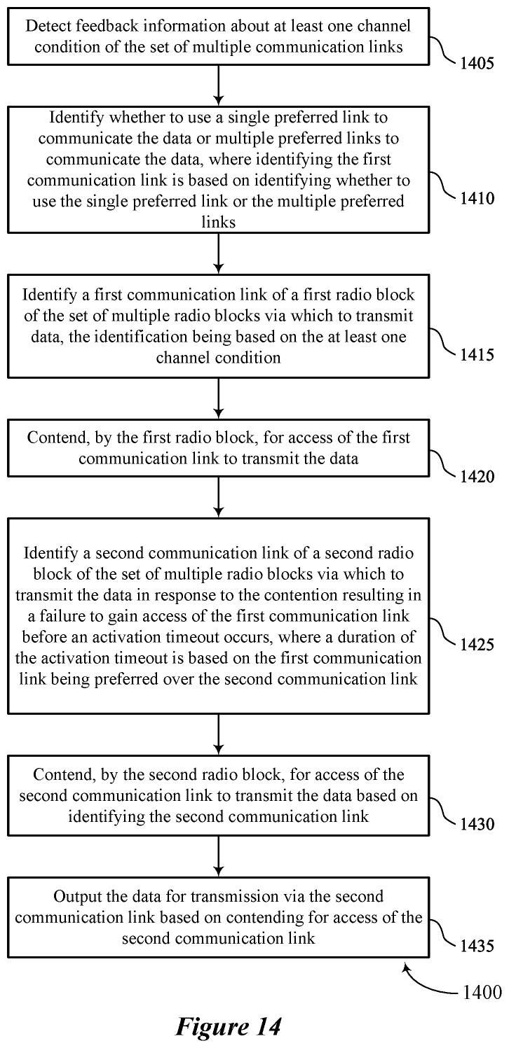

FIG. 14 shows a flowchart illustrating an example process 1400 performable by or at an AP that supports downlink provisioning with preferred links. The operations of the process 1400 may be implemented by an AP or its components as described herein. For example, the process 1400 may be performed by a wireless communication device, such as the wireless communication device 1000 described with reference to FIG. 10, operating as or within a wireless AP. In some examples, the process 1400 may be performed by a wireless AP, such as one of the APs 102 described with reference to FIG. 1.

In some examples, in block 1405, the AP may detect feedback information about at least one channel condition of the set of multiple communication links. The operations of block 1405 may be performed in accordance with examples as disclosed herein. In some implementations, aspects of the operations of block 1405 may be performed by a feedback component 1035 as described with reference to FIG. 10.

In some examples, in block 1410, the AP may identify whether to use a single preferred link to communicate the data or multiple preferred links to communicate the data, where identifying the first communication link is based on identifying whether to use the single preferred link or the multiple preferred links. The operations of block 1410 may be performed in accordance with examples as disclosed herein. In some implementations, aspects of the operations of block 1410 may be performed by a link selection component 1040 as described with reference to FIG. 10.

In some examples, in block 1415, the AP may identify a first communication link of a first radio block of the set of multiple radio blocks via which to transmit data, the identification being based on the at least one channel condition. The operations of block 1415 may be performed in accordance with examples as disclosed herein. In some implementations, aspects of the operations of block 1415 may be performed by a link selection component 1040 as described with reference to FIG. 10.

In some examples, in block 1420, the AP may contend, by the first radio block, for access of the first communication link to transmit the data. The operations of block 1420 may be performed in accordance with examples as disclosed herein. In some implementations, aspects of the operations of block 1420 may be performed by a contention component 1045 as described with reference to FIG. 10.

In some examples, in block 1425, the AP may identify a second communication link of a second radio block of the set of multiple radio blocks via which to transmit the data in response to the contention resulting in a failure to gain access of the first communication link before an activation timeout occurs, where a duration of the activation timeout is based on the first communication link being preferred over the second communication link. The operations of block 1425 may be performed in accordance with examples as disclosed herein. In some implementations, aspects of the operations of block 1425 may be performed by a link selection component 1040 as described with reference to FIG. 10.

In some examples, in block 1430, the AP may contend, by the second radio block, for access of the second communication link to transmit the data based on identifying the second communication link. The operations of block 1430 may be performed in accordance with examples as disclosed herein. In some implementations, aspects of the operations of block 1430 may be performed by a contention component 1045 as described with reference to FIG. 10.

In some examples, in block 1435, the AP may output the data for transmission via the second communication link based on contending for access of the second communication link. The operations of block 1435 may be performed in accordance with examples as disclosed herein. In some implementations, aspects of the operations of block 1435 may be performed by a data output component 1030 as described with reference to FIG. 10.

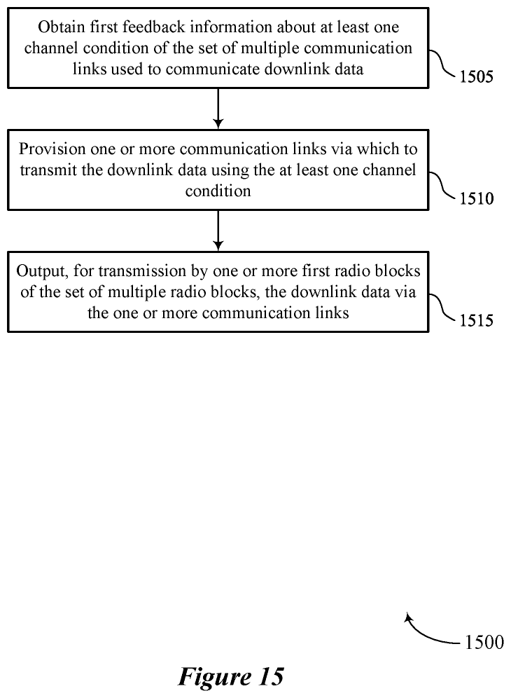

FIG. 15 shows a flowchart illustrating an example process 1500 performable by or at an AP that supports downlink provisioning with preferred links. The operations of the process 1500 may be implemented by an AP or its components as described herein. For example, the process 1500 may be performed by a wireless communication device, such as the wireless communication device 1000 described with reference to FIG. 10, operating as or within a wireless AP. In some examples, the process 1500 may be performed by a wireless AP, such as one of the APs 102 described with reference to FIG. 1.

In some examples, in block 1505, the AP may obtain first feedback information about at least one channel condition of the set of multiple communication links used to communicate downlink data. The operations of block 1505 may be performed in accordance with examples as disclosed herein. In some implementations, aspects of the operations of block 1505 may be performed by a feedback component 1035 as described with reference to FIG. 10.

In some examples, in block 1510, the AP may provision one or more communication links via which to transmit the downlink data using the at least one channel condition. The operations of block 1510 may be performed in accordance with examples as disclosed herein. In some implementations, aspects of the operations of block 1510 may be performed by a provisioning component 1050 as described with reference to FIG. 10.

In some examples, in block 1515, the AP may output, for transmission by one or more first radio blocks of the set of multiple radio blocks, the downlink data via the one or more communication links. The operations of block 1515 may be performed in accordance with examples as disclosed herein. In some implementations, aspects of the operations of block 1515 may be performed by a data output component 1030 as described with reference to FIG. 10.

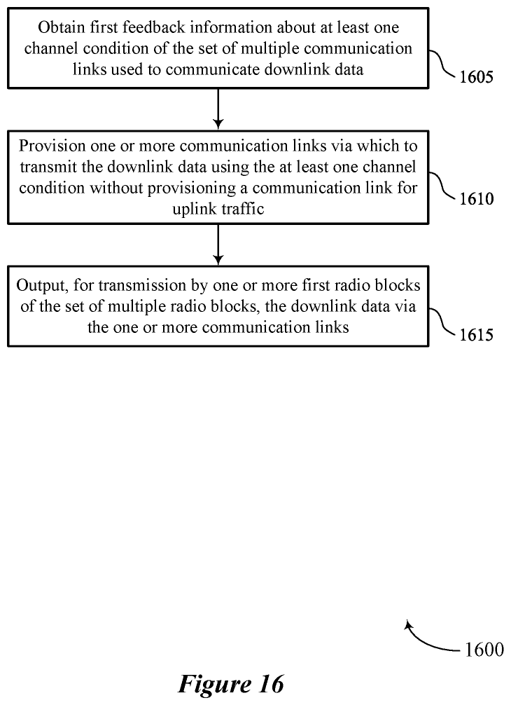

FIG. 16 shows a flowchart illustrating an example process 1600 performable by or at an AP that supports downlink provisioning with preferred links. The operations of the process 1600 may be implemented by an AP or its components as described herein. For example, the process 1600 may be performed by a wireless communication device, such as the wireless communication device 1000 described with reference to FIG. 10, operating as or within a wireless AP. In some examples, the process 1600 may be performed by a wireless AP, such as one of the APs 102 described with reference to FIG. 1.

In some examples, in block 1605, the AP may obtain first feedback information about at least one channel condition of the set of multiple communication links used to communicate downlink data. The operations of block 1605 may be performed in accordance with examples as disclosed herein. In some implementations, aspects of the operations of block 1605 may be performed by a feedback component 1035 as described with reference to FIG. 10.

In some examples, in block 1610, the AP may provision one or more communication links via which to transmit the downlink data using the at least one channel condition for downlink traffic independent of provisioning a communication link for uplink traffic. The operations of block 1610 may be performed in accordance with examples as disclosed herein. In some implementations, aspects of the operations of block 1610 may be performed by a provisioning component 1050 as described with reference to FIG. 10.

In some examples, in block 1615, the AP may output, for transmission by one or more first radio blocks of the set of multiple radio blocks, the downlink data via the one or more communication links. The operations of block 1615 may be performed in accordance with examples as disclosed herein. In some implementations, aspects of the operations of block 1615 may be performed by a data output component 1030 as described with reference to FIG. 10.

Implementation examples are described in the following numbered clauses:

Clause 1: A method for wireless communications at a wireless node, comprising: identifying a first communication link of a first radio block of a plurality of radio blocks as a preferred link via which to transmit data and a second communication link of a second radio block of the plurality of radio blocks as a non-preferred link via which to transmit the data; outputting, for transmission by the first radio block, the data and a first indication of a first activation timeout, the first indication having a first duration based at least in part on the first communication link being the preferred link; and outputting, for transmission by the second radio block, the data and a second indication of a second activation timeout, the second indication having a second duration and an offset based at least in part on the second communication link being the non-preferred link, the offset defining a duration between a start of the first duration of the first activation timeout and a start of the second duration of the second activation timeout.

Clause 2: The method of clause 1, further comprising: contending, by the first radio block, for access of the first communication link to transmit the data; outputting, by the first radio block, the data for transmission via the first communication link based at least in part on a successful contention for access to the first communication link; and sending, by the first radio block to the second radio block, a message to cancel the transmission of the data via the second communication link based at least in part on the first radio block outputting the data.

Clause 3: The method of any of clauses 1 through 2, further comprising: contending, by the first radio block, for access of the first communication link to transmit the data; contending, by the second radio block, for access to the second communication link to transmit the data after the duration of the offset has elapsed; outputting, by the second radio block, the data for transmission via the second communication link based at least in part a unsuccessful contention for access to the first communication link; and sending, by the second radio block to the first radio block, a message to cancel the transmission of the data via the first communication link based at least in part on the second radio block outputting the data.

Clause 4: The method of any of clauses 1 through 3, further comprising: queueing a preferred link command with the first radio block; and queueing a non-preferred link command with the second radio block, wherein the outputting of the data to the first radio block is after queuing the preferred link command and the outputting of the data to the second radio block is based at least in part on the non-preferred link command.

Clause 5: The method of any of clauses 1 through 4, further comprising: obtaining feedback information about at least one channel condition of the first communication link or the second communication link; and outputting, for transmission by the first radio block or the second radio block, the data and a third indication of a third activation timeout having a third duration based at least in part on the feedback information.

Clause 6: The method of clause 5, wherein the feedback information comprises at least one of a congestion level associated with a communication link, one or more traffic characteristics of the communication link, a collision rate of traffic communicated via the communication link, or any combination thereof.

Clause 7: The method of any of clauses 1 through 6, wherein identifying the first communication link is based on whether a single preferred link to communicate the data is being used or multiple preferred links to communicate the data are being used.

Clause 8: The method of any of clauses 1 through 7, further comprising: obtain the data for transmission to a wireless node, wherein identifying the first communication link as the preferred link and the second communication link as the non-preferred link is based at least in part on the data.

Clause 9: The method of any of clauses 1 through 8, wherein the first communication link comprises a first radio frequency band and the second communication link comprises a second radio frequency band.

Clause 10: The method of clause 9, wherein the first radio frequency band is greater than or equal to 5 gigahertz and the second radio frequency band is approximately 2.4 gigahertz.

Clause 11: The method of any of clauses 1 through 10, further comprising: obtaining data from various ports and output the data for transmission over various communication links; and obtaining schedules, outputting the data to the plurality of radio blocks, and identifying activation timeouts.

Clause 12: A method for wireless communications at a wireless node, comprising: detecting feedback information about at least one channel condition of the plurality of communication links; identifying a first communication link of a first radio block of the plurality of radio blocks via which to transmit data, the identification being based at least in part on the at least one channel condition; contending, by the first radio block, for access of the first communication link to transmit the data; identifying a second communication link of a second radio block of the plurality of radio blocks via which to transmit the data in response to the contention resulting in a failure to gain access of the first communication link before an activation timeout occurs, wherein a duration of the activation timeout is based at least in part on the first communication link being preferred over the second communication link; contending, by the second radio block, for access of the second communication link to transmit the data based at least in part on identifying the second communication link; and outputting the data for transmission via the second communication link based at least in part on contending for access of the second communication link.

Clause 13: The method of clause 12, further comprising: identifying whether to use a single preferred link to communicate the data or multiple preferred links to communicate the data, wherein identifying the first communication link is based at least in part on identifying whether to use the single preferred link or the multiple preferred links.

Clause 14: The method of any of clauses 12 through 13, wherein identifying the first communication link is further based at least in part on whether a collision rate in the first communication link satisfies a threshold associated with operating as a single preferred link.

Clause 15: The method of any of clauses 12 through 14, further comprising: canceling a transmission of the data via the first communication link based at least in part on additional feedback information about the first communication link, wherein identifying the second communication link is based at least in part on the cancellation.

Clause 16: The method of any of clauses 12 through 15, further comprising: identifying, in addition to the second communication link, additional available communication links of the plurality of radio blocks over which to transmit the data, said identification being based at least in part on additional feedback information about the first communication link.

Clause 17: The method of any of clauses 12 through 16, further comprising: identifying, in addition to the first communication link, additional communication links of the plurality of radio blocks over which to transmit the data as preferred links, said identification being based at least in part on the feedback information, wherein contending for the access further comprises contending for access on the additional communication links.

Clause 18: The method of any of clauses 12 through 17, further comprising: obtaining, at the at least one processor, additional feedback information about the at least one channel condition of the first communication link, wherein identifying the second communication link is based at least in part on obtaining the additional feedback information.

Clause 19: The method of any of clauses 12 through 18, wherein the feedback information comprises at least one of a congestion level about a communication link, traffic characteristics of the communication link, a collision rate of traffic communicated via the communication link, or any combination thereof.

Clause 20: The method of any of clauses 12 through 19, wherein the first communication link comprises a first radio frequency band and the second communication link comprises a second radio frequency band.

Clause 21: The method of clause 20, wherein the first radio frequency band is greater than or equal to 5 gigahertz and the second radio frequency band is around 2.4 gigahertz.

Clause 22: The method of any of clauses 12 through 21, further comprising: provisioning the first communication link and the second communication link for downlink communications, wherein the feedback information is based at least in part on provisioning the first communication link and the second communication link.

Clause 23: The method of any of clauses 12 through 22, further comprising: comparing the at least one channel condition with one or more thresholds, wherein identifying the first communication link is based at least in part on the comparison.

Clause 24: The method of any of clauses 12 through 23, further comprising: monitoring, by the first radio block, channel conditions associated with the first communication link; and monitoring, by the second radio block, channel conditions associated with the second communication link, wherein identifying the first communication link is based at least in part on at least one of monitoring by the first radio block or monitoring by the second radio block.

Clause 25: The method of any of clauses 12 through 24, wherein the first communication link is a preferred link for transmitting the data and the second communication link is a non-preferred link for transmitting the data.

Clause 26: A method for wireless communications at an AP, comprising: obtaining first feedback information about at least one channel condition of the plurality of communication links used to communicate downlink data; provisioning one or more communication links via which to transmit the downlink data using the at least one channel condition; and outputting, for transmission by one or more first radio blocks of the plurality of radio blocks, the downlink data via the one or more communication links.

Clause 27: The method of clause 26, wherein the one or more communication links are for downlink traffic and provisioning the one or more communication links occurs independent of provisioning a communication link for uplink traffic.

Clause 28: The method of any of clauses 26 through 27, further comprising: identifying whether to use a single link to communicate the downlink data or multiple links to communicate the downlink data, wherein identifying the one or more communication links is based at least in part on identifying whether to use the single link or the multiple links.

Clause 29: The method of any of clauses 26 through 28, further comprising: obtaining second feedback information about at least one second channel condition of the plurality of communication links; provisioning one or more second communication links of one or more second radio blocks of the plurality of radio blocks via which to transmit data using the at least one second channel condition; and outputting, for transmission by the one or more second radio blocks, the downlink data via the one or more second communication links.

Clause 30: The method of any of clauses 26 through 29, wherein provisioning of the one or more communication links is based at least in part on satisfying a threshold quantity of communication links, a quantity of the one or more communication links being below the threshold quantity of communication links.

Clause 31: The method of any of clauses 26 through 30, wherein outputting the downlink data for transmission by the one or more first radio blocks comprises: outputting, for transmission by a first radio block of the plurality of radio blocks, the downlink data and a first indication of a first activation timeout having a first duration based at least in part on a first communication link of the one or more communication links of the first radio block being a preferred link; and outputting, for transmission by a second radio block of the plurality radio blocks, the downlink data and a second indication of a second activation timeout having a second duration and an offset based at least in part on a second communication link of the one or more communication links being a non-preferred link, the offset defining a duration between a start of the first duration of the first activation timeout and a start of the second duration of the second activation timeout.

Clause 32: The method of any of clauses 26 through 31, further comprising: contending for access of the one or more communication links to transmit the downlink data; identifying one or more second communication links of one or more second radio blocks of the plurality of radio blocks via which to transmit the downlink data in response to the contention resulting in a failure to gain access of the one or more communication links before an activation timeout occurs, wherein a duration of the activation timeout is based at least in part on the one or more communication links being preferred over the one or more second communication links; contending, by the one or more second radio blocks, for access of the one or more second communication links to transmit the downlink data based at least in part on identifying the one or more second communication links; and outputting the downlink data for transmission via the one or more second communication links based at least in part on contending for access of the one or more second communication links.

Clause 33: The method of any of clauses 26 through 32, wherein provisioning the one or more communication links occurs independent of exchanging information between the AP and a station.

Clause 34: An apparatus for wireless communication, comprising at least one processor; a plurality of radio blocks associated with a plurality of communication links, each radio block of the plurality of radio blocks associated with a respective communication link of the plurality of communication links; and at least one memory comprising instructions executable by the at least one processor to cause the apparatus to perform a method of any of clauses 1 through 11.

Clause 35: An AP, comprising at least one transceiver, at least one memory comprising executable instructions, and one or more processors configured to execute the executable instructions and cause the AP to perform a method of any of clauses 1 through 11, wherein the at least one transceiver is configured to transmit the data, the first indication, and the second indication.

Clause 36: An apparatus, comprising at least one means for performing a method of any of clauses 1 through 11.

Clause 37: A non-transitory computer-readable medium storing code for wireless communications, the code comprising instructions executable by one or more processors to perform a method of any of clauses 1 through 11.

Clause 38: An apparatus for wireless communication, comprising at least one processor; a plurality of radio blocks associated with a plurality of communication links, each radio block of the plurality of radio blocks associated with a respective communication link of the plurality of communication links; and at least one memory comprising instructions executable by the at least one processor to cause the apparatus to perform a method of any of clauses 12 through 25.

Clause 39: An AP, comprising at least one transceiver, at least one memory comprising executable instructions, and one or more processors configured to execute the executable instructions and cause the AP to perform a method of any of clauses 12 through 25, wherein the at least one transceiver is configured to contend for access of the first communication link, wherein the at least one transceiver is configured to contend for access of the second communication link, and wherein the at least one transceiver is configured to transmit the data.

Clause 40: An apparatus, comprising at least one means for performing a method of any of clauses 12 through 25.

Clause 41: A non-transitory computer-readable medium storing code for wireless communications, the code comprising instructions executable by one or more processors to perform a method of any of clauses 12 through 25.

Clause 42: An apparatus for wireless communication, comprising at least one processor; a plurality of radio blocks associated with a plurality of communication links, each radio block of the plurality of radio blocks associated with a respective communication link of the plurality of communication links; and at least one memory comprising instructions executable by the at least one processor to cause the apparatus to perform a method of any of clauses 26 through 33.

Clause 43: An AP, comprising at least one transceiver, at least one memory comprising executable instructions, and one or more processors configured to execute the executable instructions and cause the AP to perform a method of any of clauses 26 through 33, wherein the at least one transceiver is configured to receiving the first feedback information, wherein the at least one transceiver is provision the one or more communications, and wherein the at least one transceiver is configured to transmit the downlink data.

Clause 44: An apparatus, comprising at least one means for performing a method of any of clauses 26 through 33.

Clause 45: A non-transitory computer-readable medium storing code for wireless communications, the code comprising instructions executable by one or more processors to perform a method of any of clauses 26 through 33.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,“ ” or the equivalent in context, whatever it is that is “based on ‘a,” or “based at least in part on ‘a,” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications, comprising:
at least one processor;
a plurality of radio blocks associated with a plurality of communication links, each radio block of the plurality of radio blocks associated with a respective communication link of the plurality of communication links; and
at least one memory comprising instructions executable by the at least one processor to cause the apparatus to:
identify a first communication link of a first radio block of the plurality of radio blocks as a preferred link via which to transmit data and a second communication link of a second radio block of the plurality of radio blocks as a non-preferred link via which to transmit the data;
output, for transmission by the first radio block, the data and a first indication of a first activation timeout, the first indication having a first duration based at least in part on the first communication link being the preferred link; and
output, for transmission by the second radio block, the data and a second indication of a second activation timeout, the second indication having a second duration and an offset based at least in part on the second communication link being the non-preferred link, the offset defining a duration between a start of the first duration of the first activation timeout and a start of the second duration of the second activation timeout.

2. The apparatus of claim 1, wherein the instructions are further executable by the at least one processor to cause the apparatus to:
contend, by the first radio block, for access of the first communication link to transmit the data;
output, by the first radio block, the data for transmission via the first communication link based at least in part on a successful contention for access to the first communication link; and
send, by the first radio block to the second radio block, a message to cancel the transmission of the data via the second communication link based at least in part on the first radio block outputting the data.

3. The apparatus of claim 2, wherein the message is sent via the at least one processor.

4. The apparatus of claim 1, wherein the instructions are further executable by the at least one processor to cause the apparatus to:
contend, by the first radio block, for access of the first communication link to transmit the data;
contend, by the second radio block, for access to the second communication link to transmit the data after the duration of the offset has elapsed;
output, by the second radio block, the data for transmission via the second communication link based at least in part an unsuccessful contention for access to the first communication link; and
send, by the second radio block to the first radio block, a message to cancel the transmission of the data via the first communication link based at least in part on the second radio block outputting the data.

5. The apparatus of claim 1, wherein the instructions are further executable by the at least one processor to cause the apparatus to:
queue a preferred link command with the first radio block; and
queue a non-preferred link command with the second radio block, wherein the outputting of the data to the first radio block is after queuing the preferred link command and the outputting of the data to the second radio block is based at least in part on the non-preferred link command.

6. The apparatus of claim 1, wherein the instructions are further executable by the at least one processor to cause the apparatus to:
obtain feedback information about at least one channel condition of the first communication link or the second communication link; and
output, for transmission by the first radio block or the second radio block, the data and a third indication of a third activation timeout having a third duration based at least in part on the feedback information.

7. The apparatus of claim 6, wherein the feedback information comprises at least one of a congestion level associated with a communication link, one or more traffic characteristics of the communication link, a collision rate of traffic communicated via the communication link, or any combination thereof.

8. The apparatus of claim 1, wherein to identify the first communication link is based on whether a single preferred link to communicate the data is being used or multiple preferred links to communicate the data are being used.

9. The apparatus of claim 1, wherein the instructions are further executable by the at least one processor to cause the apparatus to:
obtain the data for transmission to a wireless node, wherein identifying the first communication link as the preferred link and the second communication link as the non-preferred link is based at least in part on the data.

10. The apparatus of claim 1, wherein the first communication link comprises a first radio frequency band greater than or equal to 5 gigahertz and the second communication link comprises a second radio frequency band of approximately 2.4 gigahertz.

11. The apparatus of claim 1, wherein the instructions are further executable by the at least one processor to cause the apparatus to:
obtain data from various ports and output the data for transmission over various communication links; and
obtain schedules, output the data to the plurality of radio blocks, and identify activation timeouts.

12. An apparatus for wireless communications, comprising:
at least one processor;
a plurality of radio blocks associated with a plurality of communication links, each radio block of the plurality of radio blocks associated with a respective communication link of the plurality of communication links; and
at least one memory comprising instructions executable by the at least one processor to cause the apparatus to:
detect feedback information about at least one channel condition of the plurality of communication links;
identify a first communication link of a first radio block of the plurality of radio blocks via which to transmit data, the identification being based at least in part on the at least one channel condition;
contend, by the first radio block, for access of the first communication link to transmit the data;
identify a second communication link of a second radio block of the plurality of radio blocks via which to transmit the data in response to the contention resulting in a failure to gain access of the first communication link before an activation timeout occurs, wherein a duration of the activation timeout is based at least in part on the first communication link being preferred over the second communication link;
contend, by the second radio block, for access of the second communication link to transmit the data based at least in part on identifying the second communication link; and
output the data for transmission via the second communication link based at least in part on contending for access of the second communication link.

13. The apparatus of claim 12, wherein the instructions are further executable by the at least one processor to cause the apparatus to:
identify whether to use a single preferred link to communicate the data or multiple preferred links to communicate the data, wherein identifying the first communication link is based at least in part on identifying whether to use the single preferred link or the multiple preferred links.

14. The apparatus of claim 12, wherein identifying the first communication link is further based at least in part on whether a collision rate in the first communication link satisfies a threshold associated with operating as a single preferred link.

15. The apparatus of claim 12, wherein the instructions are further executable by the at least one processor to cause the apparatus to:
cancel a transmission of the data via the first communication link based at least in part on additional feedback information about the first communication link, wherein identifying the second communication link is based at least in part on the cancellation.

16. The apparatus of claim 12, wherein the instructions are further executable by the at least one processor to cause the apparatus to:
identify, in addition to the second communication link, additional available communication links of the plurality of radio blocks over which to transmit the data, said identification being based at least in part on additional feedback information about the first communication link.

17. The apparatus of claim 12, wherein the instructions are further executable by the at least one processor to cause the apparatus to:
identify, in addition to the first communication link, additional communication links of the plurality of radio blocks over which to transmit the data as preferred links, said identification being based at least in part on the feedback information, wherein contending for the access further comprises contending for access on the additional communication links.

18. The apparatus of claim 12, wherein the instructions are further executable by the at least one processor to cause the apparatus to:
obtain, at the at least one processor, additional feedback information about the at least one channel condition of the first communication link, wherein identifying the second communication link is based at least in part on obtaining the additional feedback information.

19. The apparatus of claim 12, wherein the feedback information comprises at least one of a congestion level about a communication link, traffic characteristics of the communication link, a collision rate of traffic communicated via the communication link, or any combination thereof.

20. The apparatus of claim 12, wherein the first communication link comprises a first radio frequency band greater than or equal to 5 gigahertz and the second communication link comprises a second radio frequency band around 2.4 gigahertz.

21. The apparatus of claim 12, wherein the instructions are further executable by the at least one processor to cause the apparatus to:
compare the at least one channel condition with one or more thresholds, wherein identifying the first communication link is based at least in part on the comparison.

22. The apparatus of claim 12, wherein the instructions are further executable by the at least one processor to cause the apparatus to:
monitor, by the first radio block, channel conditions associated with the first communication link; and
monitor, by the second radio block, channel conditions associated with the second communication link, wherein identifying the first communication link is based at least in part on at least one of monitoring by the first radio block or monitoring by the second radio block.

23. An apparatus for wireless communications, comprising:
at least one processor;
a plurality of radio blocks associated with a plurality of communication links, each radio block of the plurality of radio blocks associated with a respective communication link of the plurality of communication links; and
at least one memory comprising instructions executable by the at least one processor to cause the apparatus to:
obtain first feedback information about at least one channel condition of the plurality of communication links used to communicate downlink data;
provision one or more communication links via which to transmit the downlink data using the at least one channel condition; and
output, for transmission by one or more first radio blocks of the plurality of radio blocks, the downlink data via the one or more communication links.

24. The apparatus of claim 23, wherein the one or more communication links are for downlink traffic and provisioning the one or more communication links occurs independent of provisioning a communication link for uplink traffic.

25. The apparatus of claim 23, wherein the instructions are further executable by the at least one processor to cause the apparatus to:
identify whether to use a single link to communicate the downlink data or multiple links to communicate the downlink data, wherein identifying the one or more communication links is based at least in part on identifying whether to use the single link or the multiple links.

26. The apparatus of claim 23, wherein the instructions are further executable by the at least one processor to cause the apparatus to:
obtain second feedback information about at least one second channel condition of the plurality of communication links;
provision one or more second communication links of one or more second radio blocks of the plurality of radio blocks via which to transmit data using the at least one second channel condition; and
output, for transmission by the one or more second radio blocks, the downlink data via the one or more second communication links.

27. The apparatus of claim 23, wherein provisioning of the one or more communication links is based at least in part on satisfying a threshold quantity of communication links, a quantity of the one or more communication links being below the threshold quantity of communication links.

28. The apparatus of claim 23, wherein, to output the downlink data for transmission by the one or more first radio blocks, the instructions are further executable by the at least one processor to cause the apparatus to:
output, for transmission by a first radio block of the plurality of radio blocks, the downlink data and a first indication of a first activation timeout having a first duration based at least in part on a first communication link of the one or more communication links of the first radio block being a preferred link; and
output, for transmission by a second radio block of the plurality of radio blocks, the downlink data and a second indication of a second activation timeout having a second duration and an offset based at least in part on a second communication link of the one or more communication links being a non-preferred link, the offset defining a duration between a start of the first duration of the first activation timeout and a start of the second duration of the second activation timeout.

29. The apparatus of claim 23, wherein the instructions are further executable by the at least one processor to cause the apparatus to:
contend for access of the one or more communication links to transmit the downlink data;
identify one or more second communication links of one or more second radio blocks of the plurality of radio blocks via which to transmit the downlink data in response to the contention resulting in a failure to gain access of the one or more communication links before an activation timeout occurs, wherein a duration of the activation timeout is based at least in part on the one or more communication links being preferred over the one or more second communication links;
contend, by the one or more second radio blocks, for access of the one or more second communication links to transmit the downlink data based at least in part on identifying the one or more second communication links; and
output the downlink data for transmission via the one or more second communication links based at least in part on contending for access of the one or more second communication links.

30. The apparatus of claim 23, wherein provisioning the one or more communication links occurs independent of exchanging information between the apparatus and a station.
